(19) United States
(12) Patent Application Publication
(10) Pub. No.: US 2025/0218093 A1
(43) Pub. Date: Jul. 3, 2025

(54) DYNAMIC HEAD GENERATION FOR ANIMATION

(71) Applicant: Roblox Corporation, San Mateo, CA (US)

(72) Inventors: Maurice Kyojin CHU, Redwood City, CA (US); Ian SACHS, Corte Madera, CA (US); Dario KNEUBUHLER, Lucerne (CH)

(73) Assignee: Roblox Corporation, San Mateo, CA (US)

(21) Appl. No.: 18/990,790

(22) Filed: Dec. 20, 2024

Related U.S. Application Data
(60) Provisional application No. 63/616,499, filed on Dec. 29, 2023.

(51) Int. Cl. G06T 13/40; G06T 19/20

(52) U.S. Cl. CPC G06T 13/40; G06T 19/20; G06T 2207/30201; G06T 2207/30204; G06T 2210/16; G06T 2219/2004; G06T 2219/2021

(57) ABSTRACT

According to one aspect of the present disclosure, a computer-implemented method of dynamic head generation is provided. The method may include computing a linear blend skinning (LBS) rig associated with an avatar head based on a set of mesh deformations for a plurality of poses of the avatar head. The LBS rig may include a set of skinning joints and a set of joint weights. Each joint weight of the set of joint weights may be assigned to a vertex of a mesh of the avatar head in a neutral pose. The method may include computing an adjusted head cage for the avatar head based on a correspondence between the mesh of the avatar head in the neutral pose and a template head cage using a landmark-prediction model or a regression model. The method may include animating the avatar head based on the LBS rig and the adjusted head cage.

### CROSS-REFERENCE TO RELATED APPLICATIONS

This application is a non-provisional application that claims priority under 35 U.S.C. § 119(e) to U.S. Provisional Patent Application No. 63/616,499, filed on Dec. 29, 2023, the contents of which are hereby incorporated by reference herein in its entirety.

### TECHNICAL FIELD

Embodiments relate generally to online virtual experience platforms, and more particularly, to methods, systems, and computer readable media for dynamic head generation for animation.

### BACKGROUND

Online platforms, such as virtual experience platforms and online gaming platforms, can include head-rendering models that guide a user in creating a new avatar head for animation.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one aspect of the present disclosure, a computer-implemented method of dynamic head generation for animation is provided. The method may include computing, by a processor, a linear blend skinning (LBS) rig associated with an avatar head based on a set of mesh deformations for a plurality of poses of the avatar head. The LBS rig may include a set of skinning joints and a set of joint weights. Each joint weight of the set of joint weights may be assigned to a vertex of a mesh of the avatar head in a neutral pose. The method may include computing, by the processor, an adjusted head cage for the avatar head based on a correspondence between the mesh of the avatar head in the neutral pose and a template head cage using a landmark-prediction model or a regression model. The method may include animating, by the processor, the avatar head based on the LBS rig and the adjusted head cage.

In some implementations, animating the avatar head may include animating, by the processor, one or more facial features of the avatar head based on the LBS rig. In some implementations, animating the avatar head may include animating, by the processor, one or more of hair or clothing of the avatar head based on the adjusted head cage.

In some implementations, computing the LBS rig associated with the avatar head based on the set of mesh deformations for the plurality of poses may include generating, by the processor, the set of mesh deformations for the plurality of poses based on the mesh associated with the neutral pose of the avatar head and a plurality of pose vectors using a deformation-prediction model. In some implementations, each of the plurality of pose vectors may be associated with a respective pose of the plurality of poses. In some implementations, computing the LBS rig associated with the avatar head based on the set of mesh deformations for the plurality of poses may include performing, by the processor, an SSDR procedure based on the set of mesh deformations.

In some implementations, computing the LBS rig associated with the avatar head based on the set of mesh deformations for the plurality of poses may include detecting, by the processor, at least one collision between an external surface of the avatar head and internal features of the avatar head based on the set of mesh deformations and the mesh associated with the neutral pose. In some implementations, computing the LBS rig associated with the avatar head based on the set of mesh deformations for the plurality of poses may include adjusting, by the processor, the set of mesh deformations based on the at least one collision, the set of mesh deformations being adjusted with respect of a placement of the internal features in relation to the external surface of the avatar head, and wherein the set of mesh deformations are adjusted prior to performing the SSDR procedure.

In some implementations, detecting the at least one collision between the external surface of the avatar head and the internal features of the avatar head based on the set of mesh deformations and the mesh associated with the neutral pose may include identifying, by the processor, the external surface and the internal features of the avatar head in the neutral pose based on the mesh of the avatar head in the neutral pose. In some implementations, detecting the at least one collision between the external surface of the avatar head and the internal features of the avatar head based on the set of mesh deformations and the mesh associated with the neutral pose may include identifying, by the processor, a first plurality of depth values associated with the external surface of the avatar head in each of the plurality of poses. In some implementations, detecting the at least one collision between the external surface of the avatar head and the internal features of the avatar head based on the set of mesh deformations and the mesh associated with the neutral pose may include identifying, by the processor, a second plurality of depth values associated with the internal features of the avatar head in each of the plurality of poses. In some implementations, detecting the at least one collision between the external surface of the avatar head and the internal features of the avatar head based on the set of mesh deformations and the mesh associated with the neutral pose may include determining, by the processor, the at least one collision when at least one of the second plurality of depth values for a pose is greater than a corresponding at least one of the first plurality of depth values of the pose. In some implementations, adjusting the set of mesh deformations may include modifying the at least one of the second plurality of depth values for the pose to be less than the corresponding at least one of the first plurality of depth values for the pose.

In some implementations, performing the SSDR procedure to compute the LBS rig based on the set of mesh deformations may include computing, by the processor, a set of rigid joint transforms for each of the plurality of poses, wherein a set of input skinning weights are unchanged during the computation of the set of rigid joint transforms. In some implementations, performing the SSDR procedure to compute the LBS rig based on the set of mesh deformations may include computing, by the processor, a set of final skinning weights for each of the plurality of poses while holding the set of rigid joint transforms constant, wherein the LBS rig includes the set of rigid joint transforms and the set of final skinning weights.

In some implementations, computing the adjusted head cage for the avatar head based on the correspondence between the mesh of the avatar head in the neutral pose and a template head cage may include identifying, by the processor, a correspondence between the mesh of the avatar head in the neutral pose and an initial head cage. In some implementations, computing the adjusted head cage for the avatar head based on the correspondence between the mesh of the avatar head in the neutral pose and a template head cage may include computing, by the processor, an adjusted head cage for the avatar head based on the correspondence. In some implementations, computing the adjusted head cage for the avatar head based on the correspondence between the mesh of the avatar head in the neutral pose and a template head cage may include aligning, by the processor, the adjusted head cage to the mesh associated with the neutral pose of the avatar head.

According to another aspect of the present disclosure, a computing device is provided. The computing device may include a processor and memory storing instructions. The method storing instructions, which when executed by the processor, may cause the processor to perform operations that include computing an LBS rig associated with an avatar head based on a set of mesh deformations for a plurality of poses of the avatar head. The LBS rig may include a set of skinning joints and a set of joint weights. Each joint weight of the set of joint weights may be assigned to a vertex of a mesh of the avatar head in a neutral pose. The method storing instructions, which when executed by the processor, may cause the processor to perform operations that include computing an adjusted head cage for the avatar head based on a correspondence between the mesh of the avatar head in the neutral pose and a template head cage using a landmark-prediction model or a regression model. The method storing instructions, which when executed by the processor, may cause the processor to perform operations that include animating the avatar head based on the LBS rig and the adjusted head cage.

In some implementations, animating the avatar head may include animating, by the processor, one or more facial features of the avatar head based on the LBS rig. In some implementations, animating the avatar head may include animating, by the processor, one or more of hair or clothing of the avatar head based on the adjusted head cage.

In some implementations, computing the LBS rig associated with the avatar head based on the set of mesh deformations for the plurality of poses may include generating, by the processor, the set of mesh deformations for the plurality of poses based on the mesh associated with the neutral pose of the avatar head and a plurality of pose vectors using a deformation-prediction model. In some implementations, each of the plurality of pose vectors may be associated with a respective pose of the plurality of poses. In some implementations, computing the LBS rig associated with the avatar head based on the set of mesh deformations for the plurality of poses may include performing, by the processor, an SSDR procedure based on the set of mesh deformations.

In some implementations, computing the LBS rig associated with the avatar head based on the set of mesh deformations for the plurality of poses may include detecting, by the processor, at least one collision between an external surface of the avatar head and internal features of the avatar head based on the set of mesh deformations and the mesh associated with the neutral pose. In some implementations, computing the LBS rig associated with the avatar head based on the set of mesh deformations for the plurality of poses may include adjusting, by the processor, the set of mesh deformations based on the at least one collision, the set of mesh deformations being adjusted with respect of a placement of the internal features in relation to the external surface of the avatar head, and wherein the set of mesh deformations are adjusted prior to performing the SSDR procedure.

In some implementations, detecting the at least one collision between the external surface of the avatar head and the internal features of the avatar head based on the set of mesh deformations and the mesh associated with the neutral pose may include identifying, by the processor, the external surface and the internal features of the avatar head in the neutral pose based on the mesh of the avatar head in the neutral pose. In some implementations, detecting the at least one collision between the external surface of the avatar head and the internal features of the avatar head based on the set of mesh deformations and the mesh associated with the neutral pose may include identifying, by the processor, a first plurality of depth values associated with the external surface of the avatar head in each of the plurality of poses. In some implementations, detecting the at least one collision between the external surface of the avatar head and the internal features of the avatar head based on the set of mesh deformations and the mesh associated with the neutral pose may include identifying, by the processor, a second plurality of depth values associated with the internal features of the avatar head in each of the plurality of poses. In some implementations, detecting the at least one collision between the external surface of the avatar head and the internal features of the avatar head based on the set of mesh deformations and the mesh associated with the neutral pose may include determining, by the processor, the at least one collision when at least one of the second plurality of depth values for a pose is greater than a corresponding at least one of the first plurality of depth values of the pose. In some implementations, adjusting the set of mesh deformations may include modifying the at least one of the second plurality of depth values for the pose to be less than the corresponding at least one of the first plurality of depth values for the pose.

In some implementations, performing the SSDR procedure to compute the LBS rig based on the set of mesh deformations may include computing, by the processor, a set of rigid joint transforms for each of the plurality of poses, wherein a set of input skinning weights are unchanged during the computation of the set of rigid joint transforms. In some implementations, performing the SSDR procedure to compute the LBS rig based on the set of mesh deformations may include computing, by the processor, a set of final skinning weights for each of the plurality of poses while holding the set of rigid joint transforms constant, wherein the LBS rig includes the set of rigid joint transforms and the set of final skinning weights.

In some implementations, computing the adjusted head cage for the avatar head based on the correspondence between the mesh of the avatar head in the neutral pose and a template head cage may include identifying, by the processor, a correspondence between the mesh of the avatar head in the neutral pose and an initial head cage. In some implementations, computing the adjusted head cage for the avatar head based on the correspondence between the mesh of the avatar head in the neutral pose and a template head cage may include computing, by the processor, an adjusted head cage for the avatar head based on the correspondence. In some implementations, computing the adjusted head cage for the avatar head based on the correspondence between the mesh of the avatar head in the neutral pose and a template head cage may include aligning, by the processor, the adjusted head cage to the mesh associated with the neutral pose of the avatar head.

According to another aspect of the present disclosure, a non-transitory computer-readable medium storing instructions is provided. The instructions, which when executed by a processor, may cause the processor to perform operations including computing an LBS rig associated with an avatar head based on a set of mesh deformations for a plurality of poses of the avatar head, the LBS rig including a set of skinning joints and a set of joint weights, each joint weight of the set of joint weights being assigned to a vertex of a mesh of the avatar head in a neutral pose. The instructions, which when executed by a processor, may cause the processor to perform operations including computing an adjusted head cage for the avatar head based on a correspondence between the mesh of the avatar head in the neutral pose and a template head cage using a landmark-prediction model or a regression model. The instructions, which when executed by a processor, may cause the processor to perform operations including animating one or more facial features of the avatar head based on the LBS rig. The instructions, which when executed by a processor, may cause the processor to perform operations including animating one or more of hair or clothing of the avatar head based on the adjusted head cage.

In some implementations, computing the LBS rig associated with the avatar head based on the set of mesh deformations for the plurality of poses may include generating, by the processor, the set of mesh deformations for the plurality of poses based on the mesh associated with the neutral pose of the avatar head and a plurality of pose vectors using a deformation-prediction model. In some implementations, each of the plurality of pose vectors may be associated with a respective pose of the plurality of poses. In some implementations, computing the LBS rig associated with the avatar head based on the set of mesh deformations for the plurality of poses may include performing, by the processor, an SSDR procedure based on the set of mesh deformations.

In some implementations, computing the LBS rig associated with the avatar head based on the set of mesh deformations for the plurality of poses may include detecting, by the processor, at least one collision between an external surface of the avatar head and internal features of the avatar head based on the set of mesh deformations and the mesh associated with the neutral pose. In some implementations, computing the LBS rig associated with the avatar head based on the set of mesh deformations for the plurality of poses may include adjusting, by the processor, the set of mesh deformations based on the at least one collision, the set of mesh deformations being adjusted with respect of a placement of the internal features in relation to the external surface of the avatar head, and wherein the set of mesh deformations are adjusted prior to performing the SSDR procedure.

In some implementations, detecting the at least one collision between the external surface of the avatar head and the internal features of the avatar head based on the set of mesh deformations and the mesh associated with the neutral pose may include identifying, by the processor, the external surface and the internal features of the avatar head in the neutral pose based on the mesh of the avatar head in the neutral pose. In some implementations, detecting the at least one collision between the external surface of the avatar head and the internal features of the avatar head based on the set of mesh deformations and the mesh associated with the neutral pose may include identifying, by the processor, a first plurality of depth values associated with the external surface of the avatar head in each of the plurality of poses. In some implementations, detecting the at least one collision between the external surface of the avatar head and the internal features of the avatar head based on the set of mesh deformations and the mesh associated with the neutral pose may include identifying, by the processor, a second plurality of depth values associated with the internal features of the avatar head in each of the plurality of poses. In some implementations, detecting the at least one collision between the external surface of the avatar head and the internal features of the avatar head based on the set of mesh deformations and the mesh associated with the neutral pose may include determining, by the processor, the at least one collision when at least one of the second plurality of depth values for a pose is greater than a corresponding at least one of the first plurality of depth values of the pose. In some implementations, adjusting the set of mesh deformations may include modifying the at least one of the second plurality of depth values for the pose to be less than the corresponding at least one of the first plurality of depth values for the pose.

In some implementations, performing the SSDR procedure to compute the LBS rig based on the set of mesh deformations may include computing, by the processor, a set of rigid joint transforms for each of the plurality of poses, wherein a set of input skinning weights are unchanged during the computation of the set of rigid joint transforms. In some implementations, performing the SSDR procedure to compute the LBS rig based on the set of mesh deformations may include computing, by the processor, a set of final skinning weights for each of the plurality of poses while holding the set of rigid joint transforms constant, wherein the LBS rig includes the set of rigid joint transforms and the set of final skinning weights.

In some implementations, computing the adjusted head cage for the avatar head based on the correspondence between the mesh of the avatar head in the neutral pose and a template head cage may include identifying, by the processor, a correspondence between the mesh of the avatar head in the neutral pose and an initial head cage. In some implementations, computing the adjusted head cage for the avatar head based on the correspondence between the mesh of the avatar head in the neutral pose and a template head cage may include computing, by the processor, an adjusted head cage for the avatar head based on the correspondence. In some implementations, computing the adjusted head cage for the avatar head based on the correspondence between the mesh of the avatar head in the neutral pose and a template head cage may include aligning, by the processor, the adjusted head cage to the mesh associated with the neutral pose of the avatar head.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications; and all such modifications are within the scope of this disclosure.

### BRIEF DESCRIPTION OF DRAWINGS

FIG. 1 is a diagram of an example network environment, in accordance with some implementations.

FIG. 2 is a detailed block diagram of the avatar-head modeling component of FIG. 1, in accordance with some implementations.

FIGS. 3A-3C are schematics of an example visualization of a deformation-prediction model for an avatar head, in accordance with some implementations.

FIG. 4A is a block diagram of a conditional diffusion network, in accordance with some implementations.

FIG. 4B is a block diagram of a global encoder of the conditional diffusion network of FIG. 4A, in accordance with some implementations.

FIG. 4C is a block diagram of a conditional diffusion network block of the conditional diffusion network of FIG. 4A, in accordance with some implementations.

FIG. 5 is a schematic of an example visualization of an SSDR model for an avatar head, in accordance with some implementations.

FIG. 6A is a schematic of an example visualization of the caging-computational path that uses landmark detection, in accordance with some implementations.

FIG. 6B is a schematic of an example visualization of a cage fitted to the head mesh by a caging-model component using landmark detection, in accordance with some implementations.

FIG. 6C is a schematic of an example visualization of the caging-computational path that uses UV regression, in accordance with some implementations.

FIG. 7 is a flowchart of an example method to generate a dynamic avatar head for animation based on a neutral-pose mesh, in accordance with some implementations.

FIG. 8 is a flowchart of an example method to compute an LBS rig associated with an avatar head based on a set of mesh deformations, in accordance with some implementations.

FIG. 9 is a flowchart of an example method to detect at least one collision between an external surface of the avatar head and internal features of the avatar head based on the set of mesh deformations, in accordance with some implementations.

FIG. 10 is a flowchart of an example method to perform an SSDR procedure based on the set of mesh deformations, in accordance with some implementations.

FIG. 11 is a flowchart of an example method to compute an adjusted head cage for the avatar head, in accordance with some implementations.

FIG. 12 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

Various embodiments are described herein in the context of three-dimensional (3D) avatars that are used in a 3D virtual experience or environment. Some implementations of the techniques described herein may be applied to various types of 3D environments, such as a virtual reality (VR) conference, a 3D session (e.g., an online lecture or other type of presentation involving 3D avatars), a virtual concert, an augmented reality (AR) session, or in other types of 3D environments that may include one or more users that are represented in the 3D environment by one or more 3D avatars.

In some aspects, systems and methods are provided for manipulating 3D assets and creating new practical 3D assets. For example, practical 3D assets are 3D assets that are one or more of: easy to animate with low computational load, suitable for visual presentation in a virtual environment on a client device of any type, suitable for multiple different forms of animation, suitable for different skinning methodologies, suitable for different skinning deformations, suitable for different caging methodologies, and/or suitable for animation on various client devices. Online platforms, such as online virtual experience platforms, generally provide an ability to create, edit, store, and otherwise manipulate virtual items, virtual avatars, and other practical 3D assets to be used in virtual experiences.

For example, virtual experience platforms may include user-generated content or developer-generated content (each referred to as “UGC” herein). The UGC may be stored and implemented through the virtual experience platform, for example, by allowing users to search and interact with various virtual elements to create avatars and other items. Users may select and rearrange various virtual elements from various virtual avatars and 3D models to create new models and avatars. Avatar creators can create character heads with geometries of any desired/customized shape and size, and publish the heads in a head library hosted by the virtual experience platform.

At runtime during a virtual experience or other 3D session, a user accesses the head library to select a particular head (including various parts such as eyes, lips, nose, ears, hair, facial hair, etc.), and to rearrange the head (or parts thereof). According to implementations described herein, the virtual experience platform may take as input the overall model of the head (or parts thereof) and infer a skeletal structure that allows for appropriate motion (e.g., joint movement, rotation, etc.). In this manner, many different avatar-head parts may be rearranged to enable dynamic avatar head creation without detracting from a user experience.

The embodiments described herein utilize meshes, rigs, and cages. Mesh refers to graphical representations of head parts (e.g., eyes, nose, lips, ears, chin, cheeks, ears, forehead, etc.) and can be of arbitrary shape, size, and geometric topology. A mesh includes a plurality of three-dimensional (3D) vertices. Three or more vertices in a mesh form a mesh face. Rig refers to a virtual armature made up of a plurality of joints that are used to animate (pose) the mesh. A rig has strong correspondence to the corresponding vertices of the mesh. A cage represents an envelope of features points around the avatar head that is simpler than the mesh and has a weak correspondence to the corresponding vertices of the mesh.

To animate a character (e.g., a head of an avatar), a creator (e.g., a human developer) first needs to generate a rig, e.g., a Linear Blend Skinning (LBS) rig that includes joints and skinning weights. There are many things that go into creating a successful rig. One aspect is skinning the rig to the avatar head. Without skinning, the mesh may not deform correctly, and therefore, the animation of the avatar's face may lack realism. Skinning, as used herein, refers to the placement and correlation of joints with respect to the mesh. The joints have influence on the vertices on the mesh and move them according to various poses. Skinning is important for creating an avatar that moves accurately.

Skinning generally involves two operations: binding and weight painting. Binding is a process by which the joints are positioned (or bound) with respect to the mesh. Once the joints are bound to the mesh, weight painting is performed to assign the proper weighted influence each joint has on the different vertices of the mesh. For instance, the joint around the eye of a character exerts control over that area but not other areas (or less control over other areas). If the eye joint were to move and influence the vertices associated with the mouth, the pose may lack realism. Know skinning techniques are typically done by hand. Because a rig may be made up of hundreds of individual joints, and the joints each influence a different combination of vertices of the mesh in different ways. Thus, known skinning techniques are a time and labor-intensive process for a creator.

In addition to the rig, the creator also creates a cage based on a textured mesh (e.g., the mesh with color attributes associated therewith). The cage defines the placement hair and/or clothing on the head to fit the underlying mesh. A cage is needed since the topology of the mesh for the head may not be known during the creation process. On the other hand, the cage has a consistent topology so the placement of hairstyles can be situated relative to the cage. For example, if a creator selects a hairstyle that has sideburns, the sideburns need to be placed on the head such that the sideburns fall in front of the ear, while the rest of the hair falls behind the ear. By aligning the ear part of the cage with the ear part of the mesh, the hairstyle will generally fall in the correct place. Like skinning, caging is also a time and labor-intensive manual process.

To overcome these and other challenges, the present disclosure provides techniques for automatically computing the rig and cage based on the mesh of an avatar head. For instance, the mesh of an avatar head may be input into a deformation-prediction model that generates a set of predicted mesh deformations based on a plurality of pose vectors associated with different facial poses. Then, an SSDR process may be used to compute the joints and skinning weights based on the set of predicted mesh deformations. A textured mesh may be input into a landmark-prediction model or a regression model to compute the cage for the avatar head. In this way, a rig and cage are automatically generated and can be utilized to animate the avatar head, thereby reducing the time and manual input by the creator.

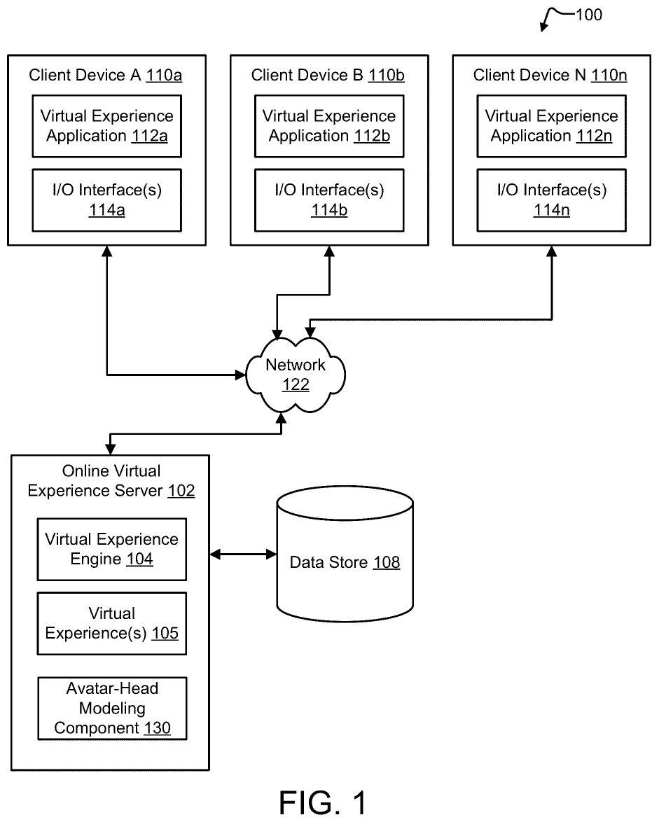

### FIG. 1: System Architecture

FIG. 1 illustrates an example network environment 100, in accordance with some implementations of the disclosure. FIG. 1 and the other figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The network environment 100 (also referred to as a “platform” herein) includes an online virtual experience server 102, a data store 108, a client device 110 (or multiple client devices), and a third-party server 118, all connected via a network 122.

The online virtual experience server 102 can include, among other things, a virtual experience engine 104, one or more virtual experiences 105, and an avatar-head modeling component 130. The online virtual experience server 102 may be configured to provide virtual experiences 105 to one or more client devices 110, and to provide automatic generation of avatar heads via the avatar-head modeling component 130, in some implementations.

Data store 108 is shown coupled to online virtual experience server 102 but in some implementations, can also be provided as part of the online virtual experience server 102. The data store may, in some implementations, be configured to store advertising data, user data, engagement data, avatar head data, and/or other contextual data in association with the avatar-head modeling component 130.

The client devices 110 (e.g., 110a, 110b, 110n) can include a virtual experience application 112 (e.g., 112a, 112b, 112n) and an I/O interface 114 (e.g., 114a, 114b, 114n), to interact with the online virtual experience server 102, and to view, for example, graphical user interfaces (GUI) through a computer monitor or display (not illustrated). In some implementations, the client devices 110 may be configured to execute and display virtual experiences, which may include virtual user engagement portals as described herein.

Network environment 100 is provided for illustration. In some implementations, the network environment 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 1002.11 network, a Wi-Fi® network, or wireless LAN (WLAN)), a cellular network (e.g., a Long Term Evolution (LTE) network), routers, hubs, switches, server computers, or a combination thereof.

In some implementations, the data store 108 may be a non-transitory computer readable memory (e.g., random access memory), a cache, a drive (e.g., a hard drive), a flash drive, a database system, or another type of component or device capable of storing data. The data store 108 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, virtual server, etc.). In some implementations, a server may be included in the online virtual experience server 102, be an independent system, or be part of another system or platform. In some implementations, the online virtual experience server 102 may be a single server, or any combination of a plurality of servers, load balancers, network devices, and other components. The online virtual experience server 102 may also be implemented on physical servers, but may utilize virtualization technology, in some implementations. Other variations of the online virtual experience server 102 are also applicable.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user (e.g., user via client device 110) with access to online virtual experience server 102.

The online virtual experience server 102 may also include a website (e.g., one or more web pages) or application back-end software that may be used to provide a user with access to content provided by online virtual experience server 102. For example, users (or developers) may access online virtual experience server 102 using the virtual experience application 112 on client device 110, respectively.

In some implementations, online virtual experience server 102 may include digital asset and digital virtual experience generation provisions. For example, the platform may provide administrator interfaces allowing the design, modification, unique tailoring for individuals, and other modification functions. In some implementations, virtual experiences may include two-dimensional (2D) games, three-dimensional (3D) games, virtual reality (VR) games, or augmented reality (AR) games, for example. In some implementations, virtual experience creators and/or developers may search for virtual experiences, combine portions of virtual experiences, tailor virtual experiences for particular activities (e.g., group virtual experiences), and other features provided through the online virtual experience server 102.

In some implementations, online virtual experience server 102 or client device 110 may include the virtual experience engine 104 or virtual experience application 112. In some implementations, virtual experience engine 104 may be used for the development or execution of virtual experiences 105. For example, virtual experience engine 104 may include a rendering engine (“renderer”) for two-dimensional (2D), three-dimensional (3D), virtual reality (VR), or augmented reality (AR) graphics, a physics engine, a collision detection engine (and collision response), sound engine, scripting functionality, haptics engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.).

The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110 (not illustrated). In some implementations, each virtual experience 105 may have a different ratio between the virtual experience engine functions that are performed on the online virtual experience server 102 and the virtual experience engine functions that are performed on the client device 110.

In some implementations, virtual experience instructions may refer to instructions that allow a client device 110 to render gameplay, graphics, and other features of a virtual experience. The instructions may include one or more of user input (e.g., physical object positioning), character position and velocity information, or commands (e.g., physics commands, rendering commands, collision commands, etc.).

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration, rather than limitation. In some implementations, any number of client devices 110 may be used.

In some implementations, each client device 110 may include an instance of the virtual experience application 112. The virtual experience application 112 may be rendered for interaction at the client device 110. During user interaction within a virtual experience or another GUI of the network environment 100, a user may create an avatar head that includes different head parts (e.g., head shapes, eyes, noses, mouths, chins, lips, cheeks, jawlines, brow lines, hair lines, ears, etc.) from different libraries. The avatar-head modeling component 130 may take as input a mesh associated with a desired avatar head.

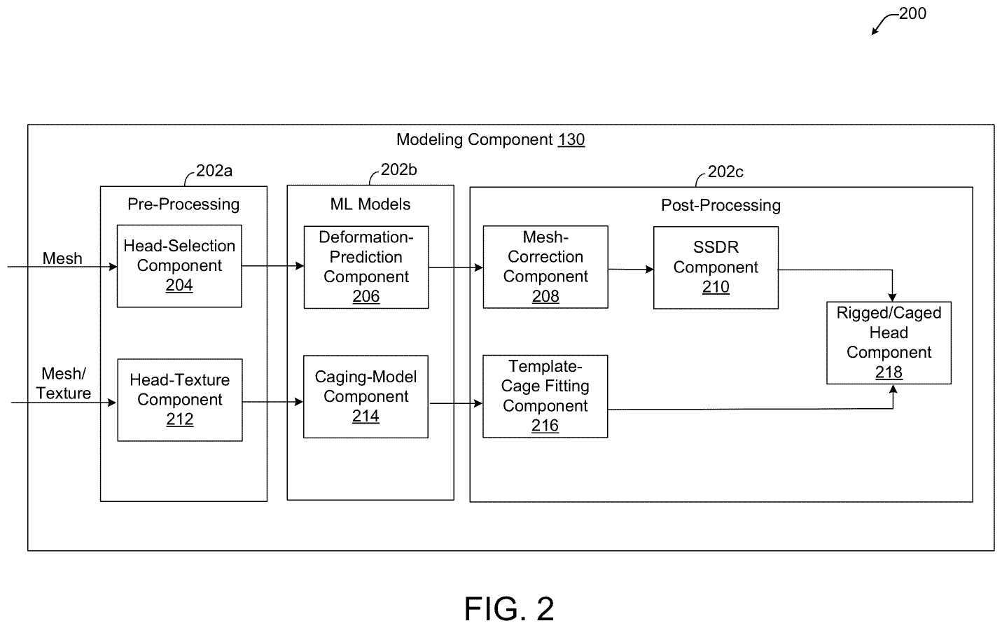

Hereinafter, a more detailed discussion of the avatar-head modeling component 130 is presented with reference to FIGS. 2-6.

### FIG. 2: Avatar-Head Modeling Component

FIG. 2 is a detailed block diagram 200 of the avatar-head modeling component 130 of FIG. 1, in accordance with some implementations. The avatar-head modeling component 130 may include a pre-processing module 202a, a machine-learning (ML) model module 202b, and a post-processing module 202c. The pre-processing module 202a may include a head-selection component 204 and a head-texture component 212. The ML model module 202b may include a deformation-prediction component 206 and a caging-model component 214. The post-processing module 202c may include a mesh-correction component 208, an SSDR component 210, a cage-fitting component 216, and a rigged/caged head component 218.

The avatar-head modeling component 130 may be arranged with a skinning-computational path and a caging-computational path. The skinning-computational path may include one or more of, e.g., the head-selection component 204, the deformation-prediction component 206, the mesh-correction component 208, and the SSDR component 210. The caging-computational path may include one or more of, e.g., the head-texture component 212, the caging-model component 214, and the template-cage fitting component 216. The rigged/caged head component 218 may be considered part of the skinning-computational path and the caging-computational path or separate from both. The operations performed by each component of the skinning-computational path and the caging-computational path are now described in detail.

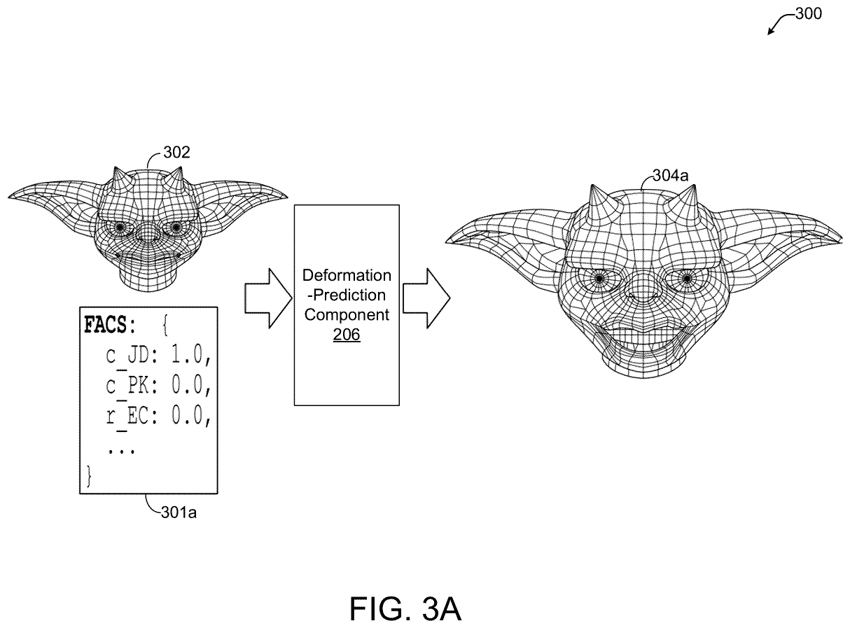

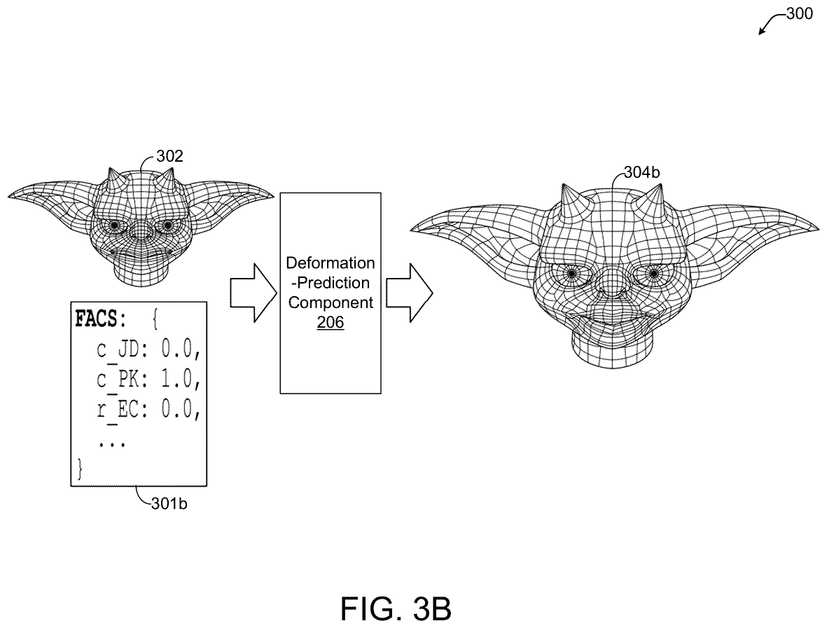

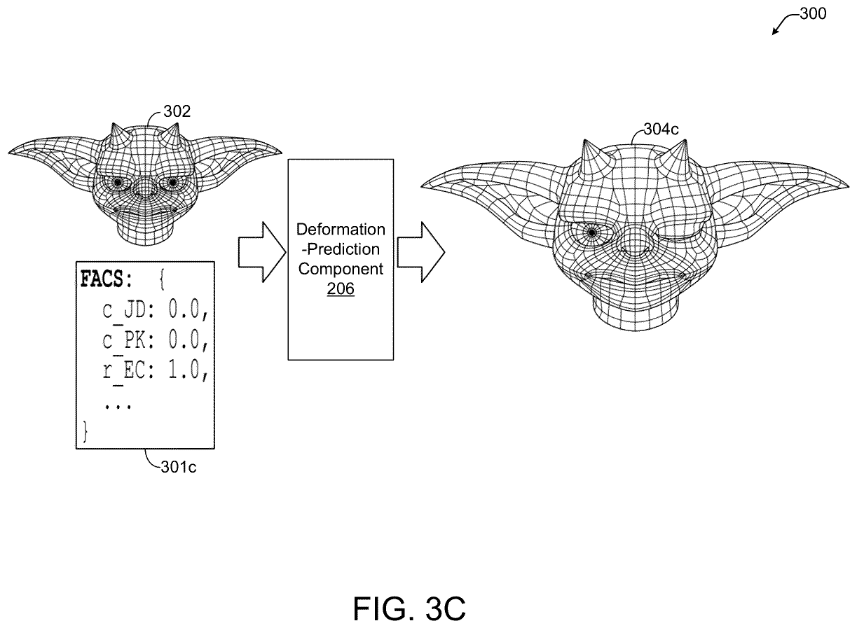

To begin the skinning computation, mesh information associated with an avatar head in neutral pose may be received by the head-selection component 204. In some implementations, the mesh information may include 3D vertex positions for the entire body (or portions thereof, including the avatar head) of the avatar in a neutral pose and corresponding mesh faces, each defined by three or more vertices. The mesh information may be segmented such that vertices associated with different body parts are indicated. Using the indication of body-part segmentation, the head-selection component 204 may identify the mesh portions associated with the avatar head (e.g., the avatar head, with or without an avatar neck). Once identified, the head-selection component 204 may provide the mesh information associated with the avatar head (or head and neck) to the deformation-prediction component 206. Additional details of the deformation-prediction component 206 are described in connection with FIGS. 3A-3C.

### FIGS. 3A-3C: Deformation-Prediction Model for an Avatar Head

FIGS. 3A-3C are schematics of an example visualization of a deformation-prediction model 300 for an avatar head, in accordance with some implementations. The deformation-prediction model 300 depicted in FIGS. 3A-3C may be implemented by the deformation-prediction component 206.

The deformation-prediction component 206 may receive mesh information 302 associated with the avatar head in neutral pose and facial action coding system (FACS) vectors 301a.

The mesh information 302 may include 3D vertices positions and the corresponding faces formed by groups of vertices (e.g., three or more vertices). The mesh information 302 may define the external features/geometry (e.g., eyes, nose, lips, chin, jawline, ears, forehead, etc.) and (optionally) internal features/geometry (e.g., teeth, tongue, gums, etc.) of the avatar head in the neutral pose. Each of the FACS vectors 301 (different examples of FACS vectors 301a, 301b, and 301c are shown in FIGS. 3A-3C respectively) encodes FACS values associated with a respective static pose for prediction.

The deformation-prediction component 206 analyzes the mesh of the avatar head in the neutral pose based on the mesh information 302. The deformation-prediction component 206 deforms the mesh based on a FACS vector to predict a set of mesh deformations associated with the static pose indicated by the FACS vector. The deformation-prediction component 206 may deform the mesh by updating the location of a vertex to a new location associated with a static pose encoded by the FACS vector.

For example, referring to FIG. 3A, the deformation-prediction component 206 receives a FACS vector 301a for a “jaw-drop” pose. As shown, the FACS vector 301a encodes a FACS value of 1.0 for the jaw-drop pose (c_JD), and FACS values of 0.0 for all other poses. Here, the deformation-prediction component 206 may identify a set of vertices associated with the jaw. This set of vertices may include vertices of the lips, jaw, teeth, tongue, etc. Then, the deformation-prediction component 206 may predict per-vertex displacement for each vertex in the set of vertices associated with the jaw.

In another example, referring to FIG. 3B, the deformation-prediction component 206 receives a FACS vector 301b for a “pucker” pose. As shown, the FACS vector 301b encodes a FACS value of 1.0 for the pucker pose (c_PK), and FACS values of 0.0 for all other poses. Here, the deformation-prediction component 206 may identify a set of vertices associated with the mouth. This set of vertices may include vertices of the lips, chin, cheeks, jaw, etc. Then, the deformation-prediction component 206 may predict per-vertex displacement for each vertex in the set of vertices associated with the mouth.

For instance, referring to FIG. 3C, the deformation-prediction component 206 receives a FACS vector 301c for an “eye-closed” pose. As shown, the FACS vector 301c encodes a FACS value of 1.0 for the eye-closed pose (c_EC), and FACS values of 0.0 for all other poses. Here, the deformation-prediction component 206 may identify a set of vertices associated with the left-eye. This set of vertices may include vertices of the eye lips, brow, upper cheek, etc. Then, the deformation-prediction component 206 may predict per-vertex displacement for each vertex in the set of vertices associated with the mouth.

Referring to FIGS. 3A-3C, in some implementations, the per-vertex displacements for each of the plurality of poses may be predicted using the conditional diffusion network, as described below.

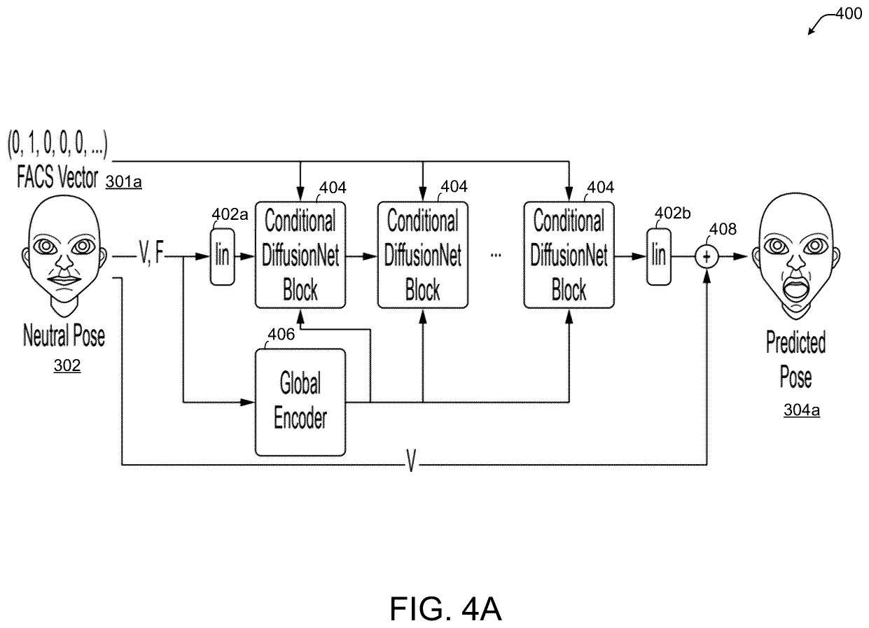

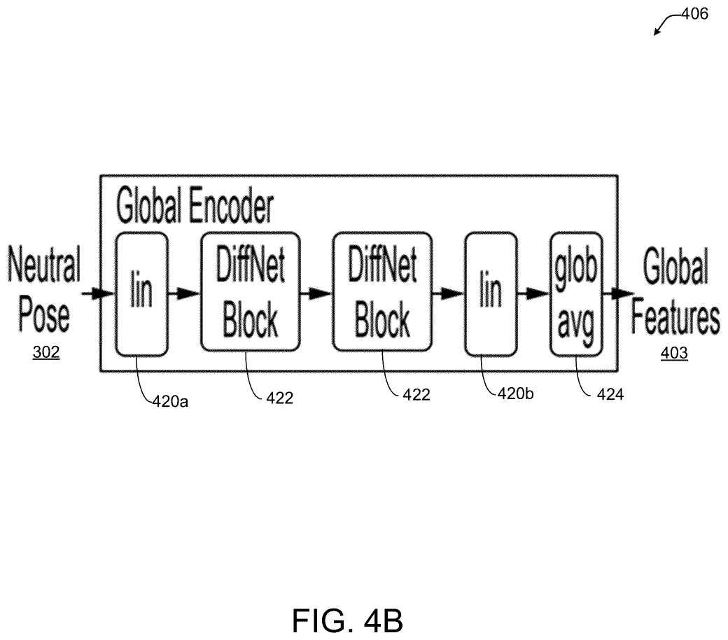

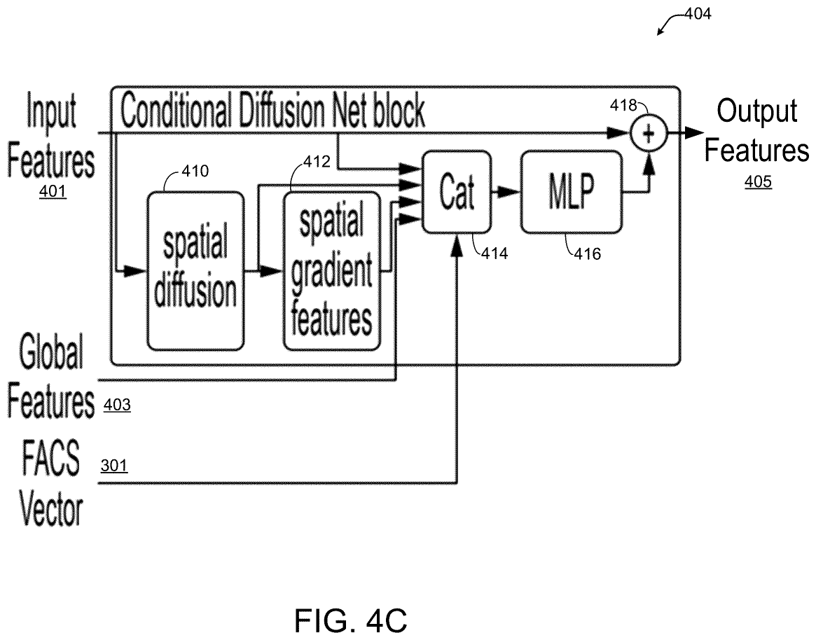

### FIGS. 4A-4C: Conditional Diffusion Network

FIG. 4A is a block diagram of a conditional diffusion network 400, in accordance with some implementations.

Referring to FIG. 4A, the conditional diffusion network 400 may include a first linear block 402a, a plurality of conditional diffusion network blocks 404 arranged in sequence, a global encoder 406, a second linear block 402b, and a combine function 408.

Mesh information 302, which indicates the 3D vertices positions (V) and corresponding mesh faces (F) of the avatar head in neutral pose, is/are input to the first linear block 402a and the global encoder 406. The first linear block 402a may perform a first matrix multiplication using a kernel and the mesh information 302. The first linear block 402a may apply a kernel to convert the size of the mesh information 302 to an input dimension for the plurality of conditional diffusion network blocks 404. A first set of features generated by the first matrix multiplication may be input as input features 401 (see FIG. 4C) into the first of the plurality of conditional diffusion network blocks 404.

Still referring to FIG. 4A, the global encoder 406 may analyze the mesh based on the mesh information 302 and provide global information to the conditional diffusion network blocks 404 to aid the deformation prediction. Additional details of the global encoder 406 are now described below with reference to FIG. 4B.

FIG. 4B is a block diagram of a global encoder 406 of the conditional diffusion network 400 of FIG. 4A, in accordance with some implementations.

Referring to FIG. 4B, the global encoder 406 may include a first linear block 420a, a plurality of diffusion network blocks 422 arranged in sequence, a second linear block 420b, and a global-averaging component 424. The first linear block 420a may perform a first matrix multiplication using a kernel and the mesh information 302. The first linear block 420a may apply the kernel to convert the size of the mesh information 302 to an input dimension for the plurality of diffusion network blocks 422. A first set of output features generated by the first matrix multiplication may be input into the first of the plurality of diffusion network blocks 422.

Each diffusion network block 422 diffuses every feature for a learned time scale, forms spatial gradient features, and applies a spatially shared pointwise multi-layer perceptron (MLP) at each vertex in the mesh. To that end, each of the diffusion network blocks 422 may include a spatial diffusion component (not shown), a spatial gradient features component (not shown), a concatenator (not shown), an MLP component (not shown), and an adder (not shown). The spatial diffusion component may perform learned diffusion for spatial communication across the entire mesh based on the features input by the first linear block 420a. The learned diffusion information may be input into the spatial gradient features component, which may identify spatial gradient features to model directional filters. The concatenator may concatenate the mesh information 302, the learned diffusion information, and the spatial gradient features. The concatenated information may be input to the MLP component. The MLP component may apply an MLP independently to each vertex to represent pointwise functions. Then, the adder may sum the pointwise functions output by the MLP component and the mesh information 302.

Still referring to FIG. 4B, the second linear block 420b may perform a second matrix multiplication using a kernel and the output from the last diffusion network block 422. The second linear block 420b may apply the kernel to convert the output from the last diffusion network block 422 to an output dimension for the global-averaging component 424. Thus, the kernel applied by the second linear block 402b may be different than the kernel applied by the first linear block 402a. In some implementations, this dimension may be the same as the size of the mesh information 302 or different. A second set of output features generated by the second matrix multiplication may be input into the global-averaging component 424. The global-averaging component 424 may perform global averaging of the second set of output features to obtain global features 403. The global features 403 may be input into each of the plurality of conditional diffusion network blocks 404, as shown in FIG. 4C.

FIG. 4C is a block diagram of a conditional diffusion network block 404 of the conditional diffusion network 400 of FIG. 4A, in accordance with some implementations.

Referring to FIG. 4C, each of the conditional diffusion network blocks 404 may include a spatial diffusion component 410, a spatial gradient features component 412, a concatenator 414, at least one MLP component 416, and a combine function 418. Different from the diffusion network block 422 described above in connection with the global encoder 406, the conditional diffusion network blocks 404 are conditioned based on variables, e.g., the FACS vector(s) 301 and the global features 403. The inputs to each conditional diffusion network block 404 may include the input features 401 (either from first linear block 402a or from a previous conditional diffusion network block 404 from the sequence of blocks 404), the FACS vector 301, and the global features 403 generated by the global encoder 406.

Still referring to FIG. 4C, the spatial diffusion component 410 may perform learned diffusion for spatial communication across the entire mesh based on the input features 401. The learned diffusion information may be input into the spatial gradient features component 412, which may identify spatial gradient features to model directional filters. The concatenator 414 may concatenate the FACS vector 301, the input features 401, the global features 403, the learned diffusion information, and the spatial gradient features. The concatenated information may be input to the MLP component 416. The MLP component 416 may apply an MLP independently to each vertex to represent pointwise functions. Then, the combine function 418 may modify the input features 401 and the pointwise functions output by the MLP component so that its output features 405 can be used to obtain the output pose. The output features 405 may be input into the next conditional diffusion network block 404 in the series or into the second linear block 402b, shown in FIG. 4A.

Referring again to FIG. 4A, the second linear block 402b may perform a second matrix multiplication using a kernel and the output features 405 from the last of the conditional diffusion network blocks 404. The second linear block 402b may apply a kernel to convert the size of the output features 405 back to the size of the mesh information 302. The combine function 408 may modify the 3D vertex positions from the mesh information 302 using the output features from the second linear block 402b to generate the set of mesh deformations 304 for the static pose associated with the respective FACS vector 301 (e.g., 301a->304a, 301b->304b, 301c->304c).

The operations described above with reference to FIGS. 4A-4C may be respectively performed for any pose of a plurality of different poses to generate a final set of mesh deformations that may be used for skinning, which is used for animating the avatar's head.

Referring back to FIG. 2, the plurality of mesh deformations (304) predicted by the deformation-prediction component 206 may be input into the mesh-correction component 208. However, at this stage, it is possible that the internal geometry (e.g., teeth, tongue, inner mouth bag, etc.) may crash through (intersect) the face surface of the avatar head based on the set of mesh deformations. Mesh-correction component 208 may detect collisions between the head surface and internal geometries and may push these internal parts to be behind the external surface of the avatar face.

Mesh-correction component 208 may identify the external surface and the internal features of the avatar head in the neutral pose based on the mesh information. The mesh faces associated with the external surface of the head mesh in neutral pose may first be identified. For instance, the mesh-correction component 208 may identify a first plurality of depth values associated with the external surface of the avatar head for one of the poses. The mesh-correction component 208 may also identify a second plurality of depth values associated with the internal features of the avatar head for that pose.

The mesh-correction component 208 may perform a rasterization operation directed at the front of the avatar head for the pose to identify internal features that have a larger Z-coordinate value (e.g., the second plurality of depth values) than the Z-coordinate values (e.g., first plurality of depth values) of corresponding external features. A collision is detected when the Z-coordinate value of one of the internal features is greater than or equal to the Z-coordinate value of a corresponding one of the external features. When a collision is detected, the mesh-correction component 208 adjusts the Z-coordinate values of the internal features for that pose to be less than the corresponding Z-coordinate values of the external features. The mesh-correction component 208 may perform these operations for each of the predicted poses. In some implementations, when no collisions are detected, no adjustments are performed.

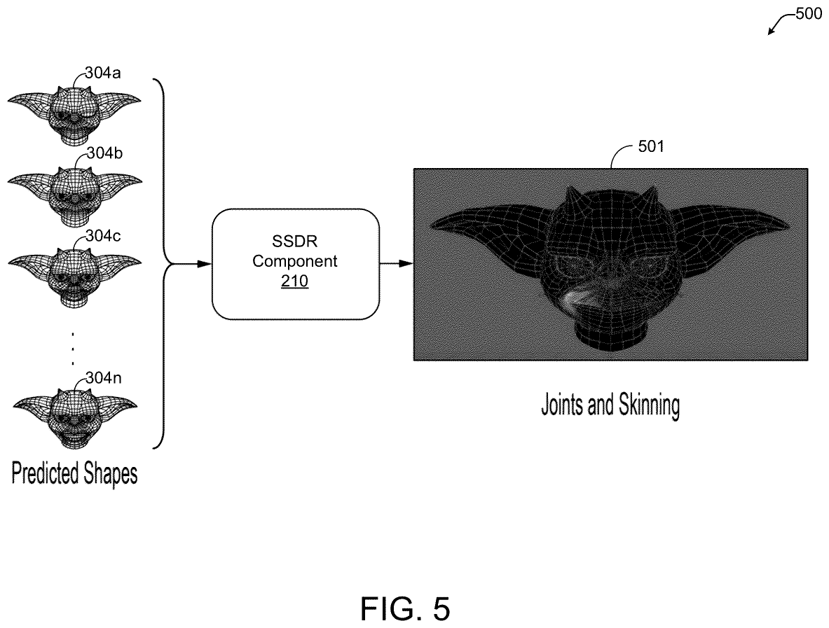

After the adjustment, the set of mesh deformations with mesh corrections may be provided to the SSDR component 210. Additional details of the SSDR component 210 and its associated operations are described below in connection with FIG. 5.

### FIG. 5: SSDR Model for an Avatar Head

FIG. 5 is a schematic of an example illustration of an SSDR model 500 for an avatar head, in accordance with some implementations. The SSDR model 500 may be implemented by the SSDR component 210.

To convert the set of mesh deformations 304 to a linear blend skinning (LBS) rig 501 that is suitable for animation, the SSDR component 210 may perform an SSDR optimization to compute the final joints and skinning for the avatar head. The optimization scheme is a coordinate descent to find the single global skinning weights and per-pose joint transforms that best fit each predicted FACS pose.

For instance, the iterations may proceed in the following way. In a first operation, while holding skinning weights constant, the SSDR component 210 identifies rigid joint transforms for every pose (e.g., 304a, 304b, 304c, . . . , 304n, etc.). Then, in a second operation, while holding all joint transforms for every pose constant (e.g., 304a, 304b, 304c, . . . , 304n, etc.), the SSDR component 210 optimizes the skinning weights. In so doing, the SSDR component 210 may compute the LBS rig 501 based on the plurality of mesh deformations 304.

The accuracy of the LBS rig 501 computed by the SSDR component 210 may be dependent on the choice of initial skinning weights. To that end, the SSDR component 210 may compute a spectral clustering of vertices of the mesh into clusters where vertices in each cluster tend to move together for the set of mesh deformations 304 for the respective FACS poses. In some implementations, a machine learning model that predicts initial skinning weights for the SSDR component 210 may be used.

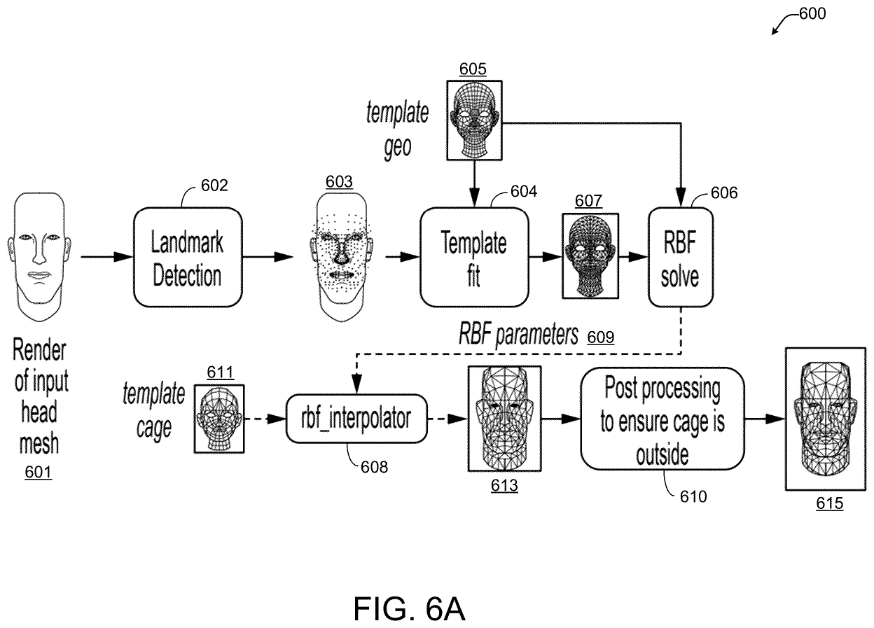

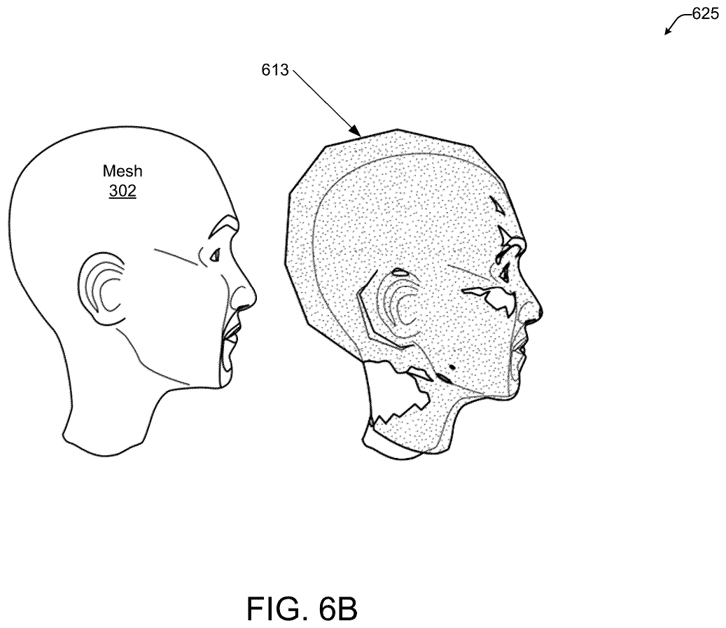

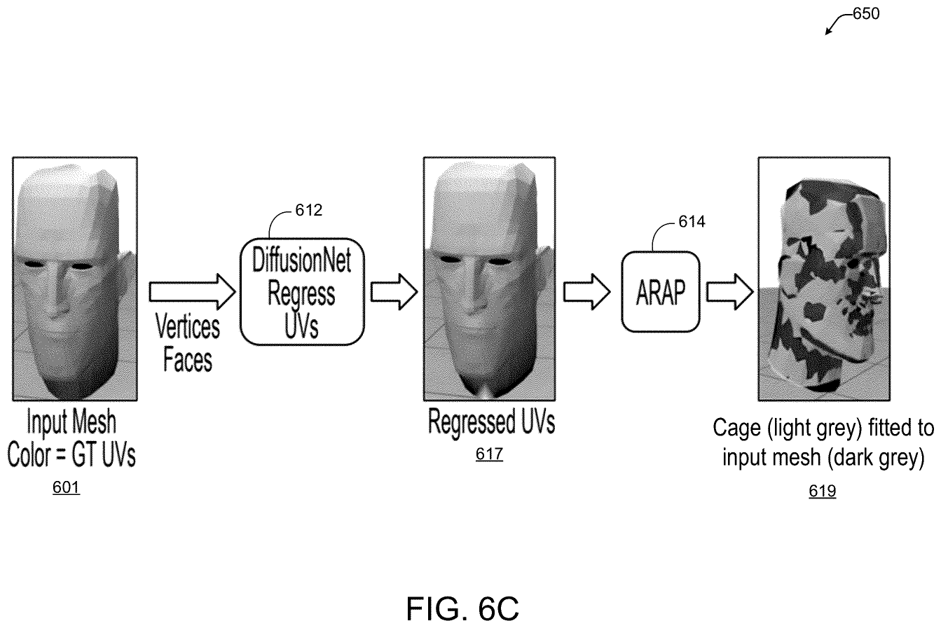

Referring again to FIG. 2, details of the caging-computational path are now described. In some implementations, the caging-computational path may include a landmark-detection model implemented by caging-model component 214. When the landmark-detection model is used, pre-processing module 202a may include a head-texture component 212. The head-texture component 212 may be configured to generate a textured mesh based on the mesh information and texture information. A textured mesh may include color and/or other attributes information assigned to corresponding vertices and/or faces of the mesh. For instance, the eye color of the avatar may be assigned to the vertices and/or faces associated with the eyes, etc. The textured-mesh information may be input into caging-model component 214, which uses the textured mesh for landmark detection. Additional details of the landmark-detection model are now described in connection with FIGS. 6A and 6B.

FIGS. 6A and 6B: Caging-Computational Path with Landmark Detection

FIG. 6A is a schematic of an example illustration of the caging-computational path 600 that uses landmark detection, in accordance with some implementations.

Referring to FIG. 6A, an example of the caging-computational path that uses landmark detection is shown. In this implementation, the caging-computational path may include a landmark-detection model 602, a template-fit model 604, a radial basis function (RBF) solver 606, an RBF interpolator 608, and a post-processing component 610. With reference to FIG. 2, the caging-model component 214 may be configured to implement operations associated with one or more of, e.g., the landmark-detection model 602, the template-fit model 604, and the RBF solver 606; and the cage-fitting component 216 may be configured to implement operations associated with one or more of, e.g., the RBF interpolator 608 and the post-processing component 610.

A textured mesh 601 of the avatar head in neutral pose may be provided as input to the landmark-detection model 602. The landmark-detection model 602 may detect a plurality of two-dimensional (2D) landmarks 603 that correspond to the different facial features of the avatar head. For instance, various points on the eyes, nose, lips, brows, etc. may be detected based on the vertices and/or corresponding textures of the textured mesh 601. The 2D landmarks 603 may be provided as input to the template-fit model 604, along with a template geometry 605 of a 3D template avatar head.

The template-fit model 604 may identify 3D landmarks associated with the textured mesh 601 by raycasting the 2D landmarks 603 onto the template geometry 605. The template-fit model 604 may deform the 3D template geometry 605 so that after the deforming, the template landmarks of a deformed geometry 607 align with the 3D landmarks of the input geometry.

For instance, the template geometry 605 and the deformed geometry 607 may have a one-to-one correspondence between vertices such that morphing the vertices of the template geometry 605 by the template-fit model 604 to match the shape of the 3D landmarks results in the deformed geometry 607. Based on these parameters, the RBF solver 606 creates a function of x, y, and z coordinates that outputs another x, y, and z coordinates. In other words, the RBF solver 606 constrains a deformation field (e.g., a non-linear function) so that points in the mesh other than the 3D landmarks can be interpolated to the appropriate location (e.g., points on the forehead, the checks, etc.). This deformation field is output as RBF parameters 609 to the RBF interpolator 608.

The RBF parameters 609 and a template cage 611 may be provided as input to the RBF interpolator 608. The RBF interpolator 608 may apply the RBF parameters 609 to the template cage 611 to identify deformation vectors associated with vertices of the template cage 611. The RBF interpolator 608 may further identify a set of vertex positions for an initial cage 613 based on the deformation vectors. The RBF interpolator 608 may generate the initial cage 613 based on the set of vertex positions identified based on the deformation vectors. The initial cage 613 may be provided as input to the post-processing component 610.

The post-processing component 610 may adjust the size of the initial cage 613 to fit the textured mesh 601, as described below with reference to FIG. 6B.

FIG. 6B is a schematic of an example illustration 625 of a cage fitted to the head mesh by the cage-fitting component 216 using landmark detection, in accordance with some implementations.

Referring to FIG. 6B, the initial cage 613 as it fits over the mesh is shown. The reason the cage does not fit the back of the head with a high degree of accuracy is that there are no landmarks on the back of the head that can be identified by the landmark-detection model 602. Thus, the post-processing component 610 may generate a final cage 615 by adjusting a shape of the initial cage 613 based on the textured mesh 601 of the avatar head. In this way, a cage may be automatically generated using landmark detection.

In some implementations, the caging-computational path may include a regression model (e.g., UV-regression model) implemented by caging-model component 214. When the regression model is used, the head-texture component 212 may be omitted from the pre-procession module 202a. This is because a mesh without texture may be used for computing a cage using the regression model. Additional details of the regression model are now described with reference to FIG. 6C.

FIG. 6C: Caging-Computational Path with UV Regression

FIG. 6C is a schematic of an example illustration of the caging-computational path 650 that uses UV regression, in accordance with some implementations.

Referring to FIG. 6C, textured mesh 601 may be input into cage-model component 214 for UV regression. UV regression is the 3D modeling process of projecting a 3D model's surface to a 2D image for texture mapping. The letters “U” and “V” denote the axes of the 2D texture while “X”, “Y”, and “Z” are used to denote the axes of the 3D object in model space.

In this implementation, the cage-model component 214 may include one or more diffusion network blocks 612 configured to regress UV coordinates from the mesh information 621. In this case, the diffusion network block(s) 612 establishes a correspondence with the cage by regressing UV coordinates 617 for the vertices based on the textured mesh 601. The diffusion network block(s) 612 may include the same or similar structure as those described above in connection with FIGS. 4A-4C.

The regressed UV coordinates 617 may be provided as input to the cage-fitting component 216, which may implement an as-rigid as-possible (ARAP) model 614 to solve for the cage deformation. Using the ARAP model 614, the cage-fitting component 216 may identify a cage deformation that matches the points on the surface of the cage at the regressed UV coordinates 617 to the corresponding vertices of the textured mesh 601. In some implementations, the cage-fitting component 216 may perform mean-fitting error operations to determine the distance between the vertices in the mesh and their corresponding points on the cage. In this way, an output cage 619 (light grey) fitted to an input mesh (dark grey) may be automatically generated for an avatar head using UV regression.

Referring again to FIG. 2, rigged/caged head component 218 may receive the LBS rig and the cage from the SSDR component 210 and the cage-fitting component 216, respectively. Using the LBS rig and the cage, the rigged/caged head component 218 may animate the avatar head. The LBS rig may be used to animate the avatar's face, while the cage may be used to animate the avatar's hair, facial hair, or head/neck clothing (e.g., hat, scarf, etc.).

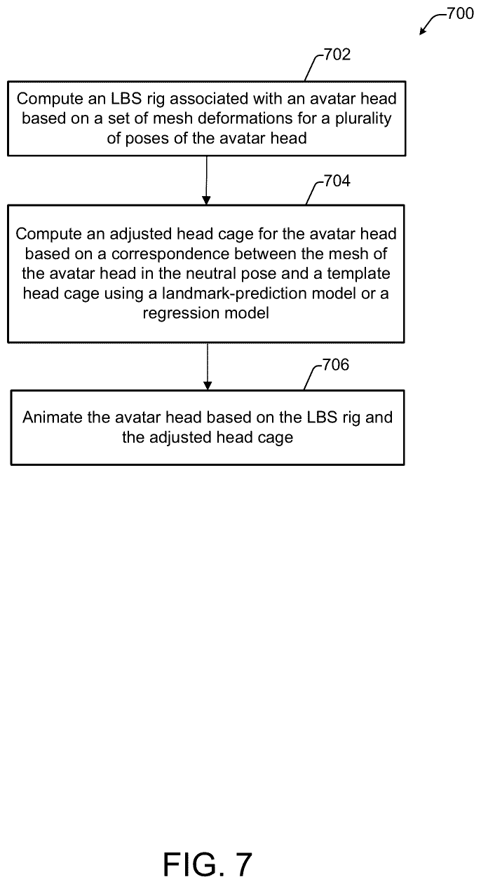

Hereinafter, a more detailed discussion of methods to generate a dynamic avatar head for animation is presented with reference to FIGS. 7-11.

### FIGS. 7-11: Example Method(s) to Generate a Dynamic Avatar Head for Animation

FIG. 7 is a flowchart of an example method 700 to generate a dynamic avatar head for animation based on a neutral-pose mesh, in accordance with some implementations.

In some implementations, method 700 can be implemented, for example, on an online virtual experience server 102 described with reference to FIG. 1. In some implementations, some or all of the method 700 can be implemented on one or more client devices 110 as shown in FIG. 1, on one or more developer devices (not illustrated), or on one or more server device(s), and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 700. In some examples, a first device is described as performing blocks of method 700. Some implementations can have one or more blocks of method 700 performed by one or more other devices (e.g., other client devices or server devices) that can send results or data to the first device.

In some implementations, method 700, or portions of the method(s) described herein, can be initiated automatically by a system. In some implementations, the implementing system is a device. For example, the method (or portions thereof) can be periodically performed, or performed based on one or more particular events or conditions, e.g., upon a user request, upon a change in avatar head dimensions, upon a change in avatar head parts, a predetermined time period having expired since the last performance of method 700 for a particular avatar model or user, and/or one or more other conditions occurring which can be specified in settings read by the methods.

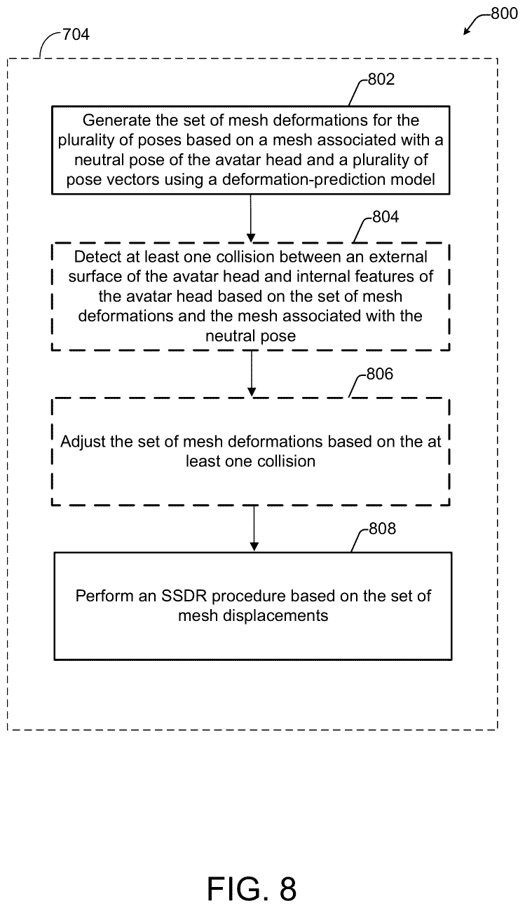

Referring to FIG. 7, method 700 may begin at block 702. At block 702, an LBS rig associated with an avatar head based on a set of mesh deformations for a plurality of poses of the avatar head may be computed. For example, referring to FIG. 2, the avatar-head modeling component 130 may be arranged with a skinning-computational path configured to compute the LBS rig. The skinning-computational path may include one or more of, e.g., the head-selection component 204, the deformation-prediction component 206, the mesh-correction component 208, and the SSDR component 210. An example method to implement block 702 is illustrated with reference to FIG. 8 below.

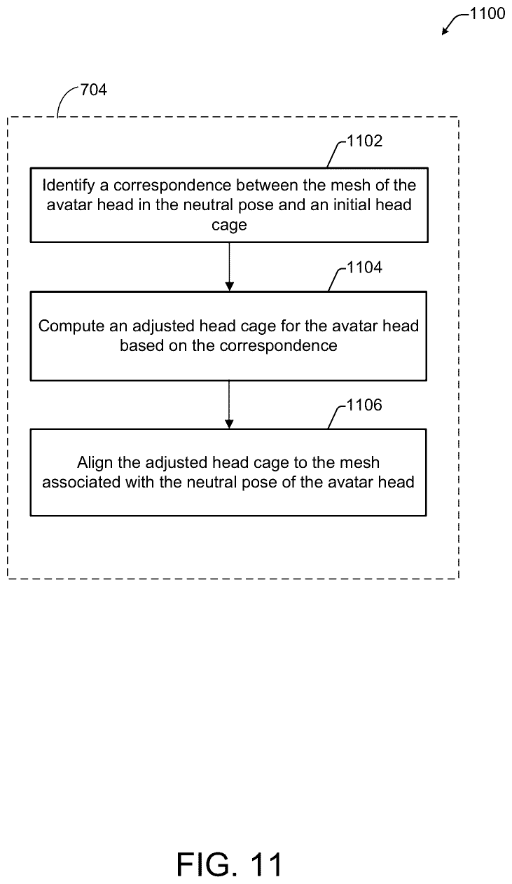

Block 702 may be followed by block 704. At block 704, an adjusted head cage for the avatar head may be computed based on a correspondence between the mesh of the avatar head in the neutral pose and a template head cage using a landmark-prediction model or a regression model. For example, referring to FIG. 2, the avatar-head modeling component 130 may be arranged with a caging-computational path. The caging-computational path may include one or more of, e.g., the head-texture component 212, the caging-model component 214, and the cage-fitting component 216. Sub-blocks associated with block 704 are described below with reference to FIG. 11.

Block 704 may be followed by block 706. At block 706, the avatar head may be animated based on the LBS rig and the adjusted head cage. For example, referring to FIG. 2, rigged/caged head component 218 may receive the LBS rig and the cage from the SSDR component 210 and the cage-fitting component 216, respectively. Using the LBS rig and the cage, the rigged/caged head component 218 may animate the avatar's head. The LBS rig may be used to animate the avatar's facial features, while the cage may be used to animate the avatar's hair, facial hair, or head/neck clothing (e.g., hat, scarf, etc.).

FIG. 8 is a flowchart of an example method 800 to compute an LBS rig associated with an avatar head based on a set of mesh deformations, in accordance with some implementations.

In some implementations, method 800 can be implemented, for example, on an online virtual experience server 102 described with reference to FIG. 1. In some implementations, some or all of the method 800 can be implemented on one or more client devices 110 as shown in FIG. 1, on one or more developer devices (not illustrated), or on one or more server device(s), and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 800. In some examples, a first device is described as performing blocks of method 800. Some implementations can have one or more blocks of method 800 performed by one or more other devices (e.g., other client devices or server devices) that can send results or data to the first device.

Referring to FIG. 8, method 800 may begin at block 802. At block 802, the set of mesh deformations for the plurality of poses may be generated based on the mesh associated with the neutral pose of the avatar head and a plurality of pose vectors using a deformation-prediction model. For example, referring to FIG. 4A, a conditional diffusion network 400 may be used to generate the set of mesh deformations using, e.g., a first linear block 402a, a plurality of conditional diffusion network blocks 404 connected in series, a global encoder 406, a second linear block 402b, and a combine function 408. Block 802 may be followed by block 804.

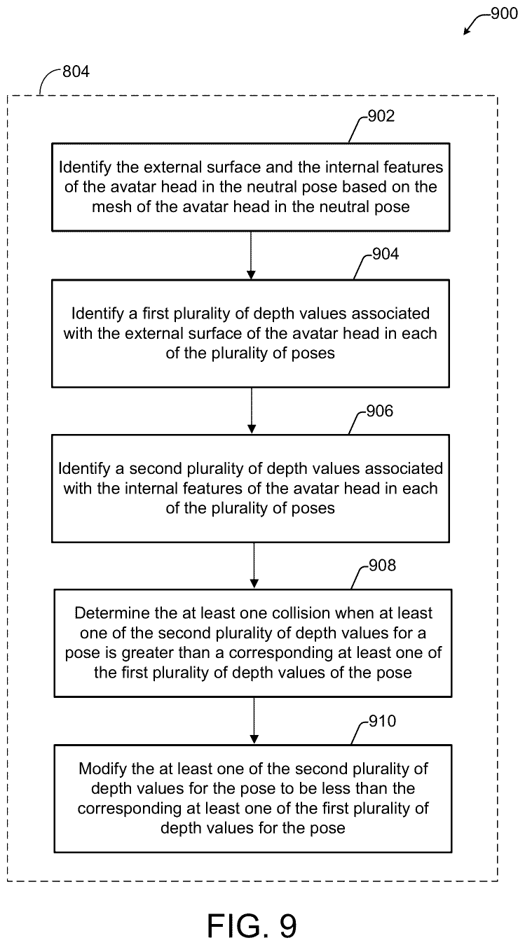

At block 804, at least one collision between an external surface of the avatar head and internal features of the avatar head may be detected based on the set of mesh deformations and the mesh associated with the neutral pose. For example, referring to FIG. 2, the plurality of mesh deformations predicted by the deformation-prediction component 206 may be input into the mesh-correction component 208. There is no guarantee that the internal geometry (e.g., teeth, tongue, inner mouth bag,) will not crash through the face surface of the avatar head based on the set of mesh deformations generated by the deformation-prediction component 206. For this reason, mesh-correction component 208 may be used to detect collisions between the head surface and internal geometries and to push these internal parts to be behind the external surface of the avatar's face. An example method to implement block 804 is described below with reference to FIG. 9.

Block 804 may be followed by block 806. At block 806, the set of mesh deformations may be adjusted based on the at least one collision. For example, referring to FIG. 2, when a collision is detected, the mesh-correction component 208 adjusts the Z-coordinate values of the internal features for that pose to be less than the corresponding Z-coordinate values of the external features. The mesh-correction component 208 may perform these operations for each of the predicted poses. Block 806 may be followed by block 808.

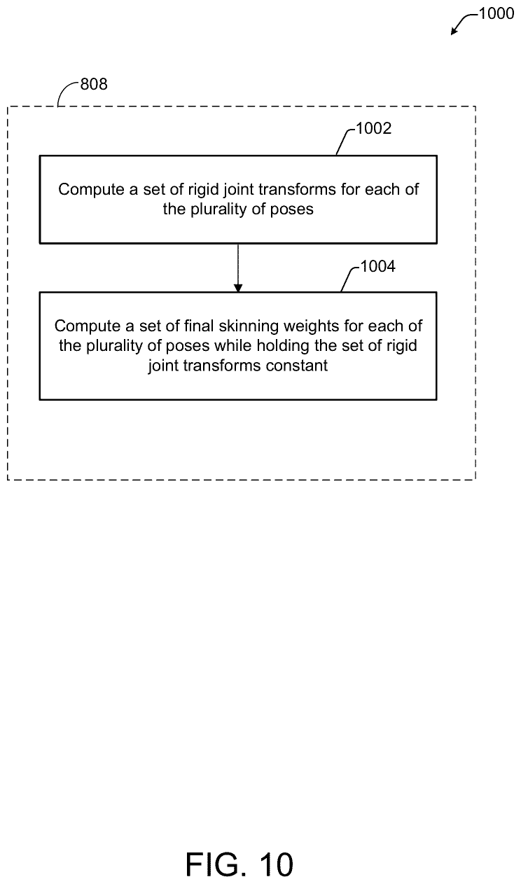

At block 808, an SSDR procedure may be performed based on the set of mesh deformations. For example, referring to FIG. 5, to convert the set of mesh deformations to a linear blend skinning (LBS) rig 501 that is suitable for animation, the SSDR component 210 may perform an SSDR optimization to compute the final joints and skinning for the head. The optimization scheme is a coordinate descent to find the single global skinning weights and per-pose joint transforms that best fit each predicted FACS pose. An example method to implement block 808 is described below with reference to FIG. 10.

FIG. 9 is a flowchart of an example method 900 to detect at least one collision between an external surface of the avatar head and internal features of the avatar head based on the set of mesh deformations, in accordance with some implementations.

In some implementations, method 900 can be implemented, for example, on an online virtual experience server 102 described with reference to FIG. 1. In some implementations, some or all of the method 900 can be implemented on one or more client devices 110 as shown in FIG. 1, on one or more developer devices (not illustrated), or on one or more server device(s), and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 900. In some examples, a first device is described as performing blocks of method 900. Some implementations can have one or more blocks of method 900 performed by one or more other devices (e.g., other client devices or server devices) that can send results or data to the first device.

Referring to FIG. 9, method 900 may begin at block 902. At block 902, the external surface and the internal features of the avatar head in the neutral pose may be identified based on the mesh of the avatar head in the neutral pose. For example, referring to FIG. 2, the mesh-correction component 208 may identify the external surface and the internal features of the avatar head in the neutral pose based on the mesh information. Block 902 may be followed by block 904.

At block 904, a first plurality of depth values associated with the external surface of the avatar head in each of the plurality of poses may be identified. For example, referring to FIG. 2, the approach is to first identify the visible faces of the head mesh in neutral pose. For instance, the mesh-correction component 208 may identify a first plurality of depth values associated with the external surface of the avatar head for one of the poses. Block 904 may be followed by block 906.

At block 906, a second plurality of depth values associated with the internal features of the avatar head in each of the plurality of poses may be identified. For example, referring to FIG. 2, the mesh-correction component 208 may identify a second plurality of depth values associated with the internal features of the avatar head for that pose. Block 906 may be followed by block 908.

At block 908, the at least one collision may be determined when at least one of the second plurality of depth values for a pose is greater than a corresponding at least one of the first plurality of depth values of the pose. For example, referring to FIG. 2, the mesh-correction component 208 may perform a rasterization operation directed at the front of the avatar head for the pose to identify any internal features that have a larger Z-coordinate value (e.g., the second plurality of depth values) than the Z-coordinate values (e.g., first plurality of depth values) of corresponding external features. A collision is detected when the Z-coordinate value of one of the internal features is greater than or equal to the Z-coordinate value of a corresponding one of the external features. Block 908 may be followed by block 910.

At block 910, the at least one of the second plurality of depth values for the pose may be modified to be less than the corresponding at least one of the first plurality of depth values for the pose. For example, referring to FIG. 2, when a collision is detected, the mesh-correction component 208 modifies the Z-coordinate values of the internal features for that pose to be less than the corresponding Z-coordinate values of the external features. Block 910 may conclude the operations associated with block 804.

FIG. 10 is a flowchart of an example method 1000 to perform an SSDR procedure based on the set of mesh deformations, in accordance with some implementations.

In some implementations, method 1000 can be implemented, for example, on an online virtual experience server 102 described with reference to FIG. 1. In some implementations, some or all of the method 1000 can be implemented on one or more client devices 110 as shown in FIG. 1, on one or more developer devices (not illustrated), or on one or more server device(s), and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 1000. In some examples, a first device is described as performing blocks of method 1000. Some implementations can have one or more blocks of method 1000 performed by one or more other devices (e.g., other client devices or server devices) that can send results or data to the first device.

Referring to FIG. 10, method 1000 may begin at block 1002. At block 1002, a set of rigid joint transforms may be computed for each of the plurality of poses. For example, referring to FIG. 5, in a first operation, while holding skinning weights constant, the SSDR component 210 identifies the best rigid joint transforms for every pose. Block 1002 may be followed by block 1004.

At block 1004, a set of final skinning weights may be computed for each of the plurality of poses while holding the set of rigid joint transforms constant. For example, referring to FIG. 5, in a second operation, while holding all joint transforms for every pose constant, the SSDR component 210 optimizes the skinning weights. In so doing, the SSDR component 210 may compute the LBS rig 501 based on the plurality of mesh deformations 304. Block 1004 may conclude the operations associated with block 808, and hence, block 702.

FIG. 11 is a flowchart of an example method 1100 to compute an adjusted head cage for the avatar head, in accordance with some implementations.

In some implementations, method 1100 can be implemented, for example, on an online virtual experience server 102 described with reference to FIG. 1. In some implementations, some or all of the method 1100 can be implemented on one or more client devices 110 as shown in FIG. 1, on one or more developer devices (not illustrated), or on one or more server device(s), and/or on a combination of developer device(s), server device(s) and client device(s). In described examples, the implementing system includes one or more digital processors or processing circuitry (“processors”), and one or more storage devices (e.g., a data store 108 or other storage). In some implementations, different components of one or more servers and/or clients can perform different blocks or other parts of the method 1100. In some examples, a first device is described as performing blocks of method 1100. Some implementations can have one or more blocks of method 1100 performed by one or more other devices (e.g., other client devices or server devices) that can send results or data to the first device.

Referring to FIG. 11, method 1100 may begin at block 1102. At block 1102, a correspondence between the mesh of the avatar head in the neutral pose and an initial head cage may be identified. For example, referring to FIG. 6A, a textured mesh 601 of the avatar head in neutral pose may be input into the landmark-detection model 602. The landmark-detection model 602 may detect a plurality of 2D landmarks 603 that correspond to the different facial features of the avatar head. For instance, the eyes, nose, lips, brows, etc. may be detected based on the vertices and/or corresponding textures of the textured mesh 601. The 2D landmarks 603 may be input into the template-fit model 604, along with a template geometry 605 of a 3D template avatar head. The template-fit model 604 may identify 3D landmarks associated with the textured mesh 601 by raycasting the 2D landmarks 603 onto the template geometry 605. Then, the template-fit model 604 may deform the 3D template geometry 605 so that its template landmarks align with the 2D landmarks 603 of the input geometry to obtain a deformed geometry 607. For instance, the template geometry 605 and the deformed geometry 607 have a one-to-one correspondence between vertices so the template-fit model 604 can determine how to morph the vertices of the template geometry 605 to the deformed geometry 607 to match the shape of the 3D landmarks. Based on these parameters, the RBF solver 606 creates a function of x, y, and z coordinates that outputs another x, y, and z coordinates. In other words, the RBF solver 606 constrains a deformation field (a non-linear function) so that every other point in the mesh other than the 3D landmarks can be interpolated to the appropriate location (e.g., the forehead, the checks, etc.). This deformation field is output as RBF parameters 609 to the RBF interpolator 608. In another example, referring to FIG. 6C, the cage-model component 214 may include one or more diffusion network blocks 612 configured to regress UV coordinates from the textured mesh 601. In this case, the diffusion network block(s) 612 establishes a correspondence with the cage by regressing UV coordinates 617 for the vertices based on the mesh information 621. Block 1102 may be followed by block 1104.

At block 1104, an adjusted head cage may be computed for the avatar head based on the correspondence. For example, referring to FIG. 6A, the RBF parameters 609 and a template cage 611 may be input to the RBF interpolator 608. The RBF interpolator 608 may apply the RBF parameters 609 to the template cage 611 to identify deformation vectors associated with vertices of the template cage 611. Then, the RBF interpolator 608 may identify a set of vertex positions for an initial cage 613 based on the deformation vectors. The RBF interpolator 608 may generate the initial cage 613 based on the set of vertex positions identified based on the deformation vectors. The initial cage 613 may be input to the post-processing component 610. The post-processing component 610 may adjust the size of the initial cage 613 to better fit the mesh. For example, referring to FIG. 6B, the initial cage 613 as it fits over the mesh is shown. An example reason why the cage does not fit the back of the head with a high degree of accuracy is that there are no landmarks on the back of the head that can be identified by the landmark-detection model 602. Thus, the post-processing component 610 may generate a final cage 615 by adjusting a shape of the initial cage 613 based on the mesh information 302 of the avatar head. In this way, a cage may be automatically generated using landmark detection. In another example, referring to FIG. 6C, the UV coordinates 617 may be input to the cage-fitting component 216, which may implement an ARAP model 614 to solve for the cage deformation. Using the ARAP model 614, the cage-fitting component 216 may identify the cage deformation that best matches the points on the surface of the cage at the regressed UV coordinates 617 to the corresponding vertices of the mesh. Block 1104 may be followed by block 1106.

At block 1106, the adjusted head cage may be aligned to the mesh associated with the neutral pose of the avatar head. For example, referring to FIGS. 6A-6C, the adjusted cage computing using either landmark detection or UV regression may be fit to the mesh. Block 1106 may conclude the operations associated with block 704.

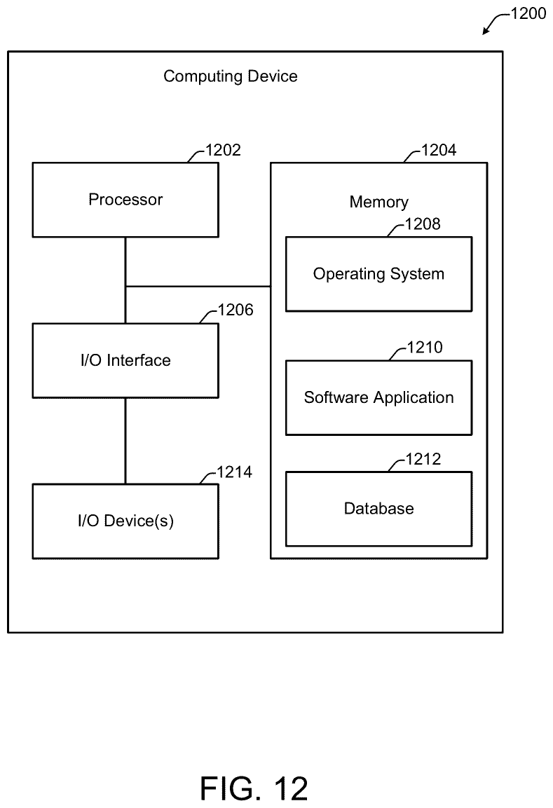

### FIG. 12: Computing Devices

Hereinafter, a more detailed description of various computing devices that may be used to implement different devices and/or components illustrated in FIG. 1 is provided with reference to FIG. 12.

FIG. 12 is a block diagram of an example computing device 1200 which may be used to implement one or more features described herein, in accordance with some implementations. In one example, computing device 1200 may be used to implement a computer device, (e.g., 102, 110 of FIG. 1), and perform appropriate operations as described herein. Computing device 1200 can be any suitable computer system, server, or other electronic or hardware device. For example, the computing device 1200 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, computing device 1200 includes a processor 1202, a memory 1204, input/output (I/O) interface 1206, and audio/video input/output devices 1214 (e.g., display screen, touchscreen, display goggles or glasses, audio speakers, headphones, microphone, etc.).

Processor 1202 can be one or more processors and/or processing circuits to execute program code and control basic operations of the computing device 1200. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1204 is typically provided in computing device 1200 for access by the processor 1202, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1202 and/or integrated therewith. Memory 1204 can store software operating on the computing device 1200 by the processor 1202, including an operating system 1208, software application 1210 and associated database 1212. In some implementations, the software application 1210 can include instructions that enable processor 1202 to perform the functions described herein. Software application 1210 may include some or all of the functionality required to compute an LBS rig and a head cage for an avatar head based on its head mesh. In some implementations, one or more portions of software application 1210 may be implemented in dedicated hardware such as an application-specific integrated circuit (ASIC), a programmable logic device (PLD), a field-programmable gate array (FPGA), a machine learning processor, etc. In some implementations, one or more portions of software application 1210 may be implemented in general purpose processors, such as a central processing unit (CPU) or a graphics processing unit (GPU). In various implementations, suitable combinations of dedicated and/or general-purpose processing hardware may be used to implement software application 1210.

For example, software application 1210 stored in memory 1204 can include instructions for retrieving user data, for displaying/presenting avatars heads or head parts, and/or other functionality or software such as the avatar-head modeling component 130, virtual experience engine 104, and/or virtual experience application 112. Any of the software in memory 1204 can alternatively be stored on any other suitable storage location or computer-readable medium. In addition, memory 1204 (and/or other connected storage device(s)) can store instructions and data used in the features described herein. Memory 1204 and any other type of storage (magnetic disk, optical disk, magnetic tape, or other tangible media) can be considered “storage” or “storage devices.”

I/O interface 1206 can provide functions to enable interfacing the computing device 1200 with other systems and devices. For example, network communication devices, storage devices (e.g., memory and/or data store 106), and input/output devices can communicate via I/O interface 1206. In some implementations, the I/O interface 1206 can connect to interface devices including input devices (keyboard, pointing device, touchscreen, microphone, camera, scanner, etc.) and/or output devices (display device, speaker devices, printer, motor, etc.).

For ease of illustration, FIG. 12 shows one block for each of processor 1202, memory 1204, I/O interface 1206, software blocks (e.g., operating system 1208 and software application) 1210, and database 1212. These blocks may represent one or more processors or processing circuitries, operating systems, memories, I/O interfaces, applications, and/or software modules. In other implementations, computing device 1200 may not have all of the components shown and/or may have other elements including other types of elements instead of, or in addition to, those shown herein. While the online virtual experience server 102 are described as performing operations as described in some implementations herein, any suitable component or combination of components of online virtual experience server 102, or similar system, or any suitable processor or processors associated with such a system, may perform the operations described.

A user device can also implement and/or be used with features described herein. Example user devices can be computer devices including some similar components as the computing device 1200, e.g., processor(s) 1202, memory 1204, and I/O interface 1206. An operating system, software and applications suitable for the client device can be provided in memory and used by the processor. The I/O interface for a client device can be connected to network communication devices, as well as to input and output devices, e.g., a microphone for capturing sound, a camera for capturing images or video, audio speaker devices for outputting sound, a display device for outputting images or video, or other output devices. A display device within the audio/video input/output devices 1214, for example, can be connected to (or included in) the computing device 1200 to display images pre- and post-processing as described herein, where such display device can include any suitable display device, e.g., an liquid crystal display (LCD), light-emitting diode (LED), or plasma display screen, cathode ray tube (CRT), television, monitor, touchscreen, 3D display screen, projector, or other visual display device. Some implementations can provide an audio output device, e.g., voice output or synthesis that speaks text.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

In some implementations, some or all of the methods can be implemented on a system such as one or more client devices. In some implementations, one or more methods described herein can be implemented, for example, on a server system, and/or on both a server system and a client system. In some implementations, different components of one or more servers and/or clients can perform different blocks, operations, or other parts of the methods.

One or more methods described herein (e.g., methods 700, 800, 900, 1000, and 1100) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g. Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more implementations described herein may utilize user data, e.g., an image or video of a user's face, user's head, user's body, etc. captured by using a camera and utilized by a virtual experience platform to render an avatar associated with the user. Some implementations may utilize audio provided by the user, text provided by the user, or other media provided by the user. Capture, storage, and use of user provided data (images, video, audio, text, other media, etc.) is made in accordance with user-specified preferences (e.g., capture, store, and use only on client device; on a server device; or both) and parameters (e.g., duration of storage, etc.). Additionally, user provided data is utilized in accordance with applicable laws and regulations, e.g., related to user privacy, user safety etc. Options are provided to the user to enable them to control whether and how the virtual experience platform may capture, store, and/or utilize user provided data. Additionally, user provided data are treated (e.g., subjected to aggregation, obfuscation, etc.) in such a way that the data cannot be linked back to the user (e.g., identify the user). Appropriate encryption technologies are utilized for data, whether in storage, during transfer over a network or other interface, or in memory, during use. The user provided data are used specifically for the purposes of providing a virtual experience for the user avatar.

One or more methods described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the live feedback data for output (e.g., for display). In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method of dynamic head generation for animation, comprising:
computing, by a processor, a linear blend skinning (LBS) rig associated with an avatar head based on a set of mesh deformations for a plurality of poses of the avatar head, the LBS rig including a set of skinning joints and a set of joint weights, each joint weight of the set of joint weights being assigned to a vertex of a mesh of the avatar head in a neutral pose;
computing, by the processor, an adjusted head cage for the avatar head based on a correspondence between the mesh of the avatar head in the neutral pose and a template head cage using a landmark-prediction model or a regression model; and
animating, by the processor, the avatar head based on the LBS rig and the adjusted head cage.

2. The method of claim 1, wherein animating the avatar head comprises:
animating, by the processor, one or more facial features of the avatar head based on the LBS rig; and
animating, by the processor, one or more of hair or clothing of the avatar head based on the adjusted head cage.

3. The method of claim 1, wherein computing the LBS rig associated with the avatar head based on the set of mesh deformations for the plurality of poses comprises:
generating, by the processor, the set of mesh deformations for the plurality of poses based on the mesh associated with the neutral pose of the avatar head and a plurality of pose vectors using a deformation-prediction model, each of the plurality of pose vectors being associated with a respective pose of the plurality of poses; and
performing, by the processor, a Smooth Skinning Decomposition for Rigid Bones (SSDR) procedure based on the set of mesh deformations.

4. The method of claim 3, wherein computing the LBS rig associated with the avatar head based on the set of mesh deformations for the plurality of poses comprises:
detecting, by the processor, at least one collision between an external surface of the avatar head and internal features of the avatar head based on the set of mesh deformations and the mesh associated with the neutral pose; and
adjusting, by the processor, the set of mesh deformations based on the at least one collision, the set of mesh deformations being adjusted with respect of a placement of the internal features in relation to the external surface of the avatar head, and wherein the set of mesh deformations are adjusted prior to performing the SSDR procedure.

5. The method of claim 4, wherein:
detecting the at least one collision between the external surface of the avatar head and the internal features of the avatar head based on the set of mesh deformations and the mesh associated with the neutral pose comprises:
identifying, by the processor, the external surface and the internal features of the avatar head in the neutral pose based on the mesh of the avatar head in the neutral pose;
identifying, by the processor, a first plurality of depth values associated with the external surface of the avatar head in each of the plurality of poses;
identifying, by the processor, a second plurality of depth values associated with the internal features of the avatar head in each of the plurality of poses; and
determining, by the processor, the at least one collision when at least one of the second plurality of depth values for a pose is greater than a corresponding at least one of the first plurality of depth values of the pose, and
adjusting the set of mesh deformations comprises:
modifying the at least one of the second plurality of depth values for the pose to be less than the corresponding at least one of the first plurality of depth values for the pose.

6. The method of claim 3, wherein performing the SSDR procedure to compute the LBS rig based on the set of mesh deformations comprises:
computing, by the processor, a set of rigid joint transforms for each of the plurality of poses, wherein a set of input skinning weights are unchanged during the computation of the set of rigid joint transforms; and
computing, by the processor, a set of final skinning weights for each of the plurality of poses while holding the set of rigid joint transforms constant, wherein the LBS rig includes the set of rigid joint transforms and the set of final skinning weights.

7. The method of claim 1, wherein computing the adjusted head cage for the avatar head based on the correspondence between the mesh of the avatar head in the neutral pose and a template head cage comprises:
identifying, by the processor, a correspondence between the mesh of the avatar head in the neutral pose and an initial head cage;
computing, by the processor, an adjusted head cage for the avatar head based on the correspondence; and
aligning, by the processor, the adjusted head cage to the mesh associated with the neutral pose of the avatar head.

8. A computing device, comprising:
a processor; and
memory storing instructions, which when executed by the processor, cause the processor to perform operations comprising:
computing a linear blend skinning (LBS) rig associated with an avatar head based on a set of mesh deformations for a plurality of poses of the avatar head, the LBS rig including a set of skinning joints and a set of joint weights, each joint weight of the set of joint weights being assigned to a vertex of a mesh of the avatar head in a neutral pose;
computing an adjusted head cage for the avatar head based on a correspondence between the mesh of the avatar head in the neutral pose and a template head cage using a landmark-prediction model or a regression model; and
animating the avatar head based on the LBS rig and the adjusted head cage.

9. The computing device of claim 8, wherein animating the avatar head comprises:
animating one or more facial features of the avatar head based on the LBS rig; and
animating one or more of hair or clothing of the avatar head based on the adjusted head cage.

10. The computing device of claim 8, wherein computing the LBS rig associated with the avatar head based on the set of mesh deformations for the plurality of poses comprises:
generating the set of mesh deformations for the plurality of poses based on the mesh associated with the neutral pose of the avatar head and a plurality of pose vectors using a deformation-prediction model, each of the plurality of pose vectors being associated with a respective pose of the plurality of poses; and
performing a Smooth Skinning Decomposition for Rigid Bones (SSDR) procedure based on the set of mesh deformations.

11. The computing device of claim 10, wherein computing the LBS rig associated with the avatar head based on the set of mesh deformations for the plurality of poses comprises:
detecting at least one collision between an external surface of the avatar head and internal features of the avatar head based on the set of mesh deformations and the mesh associated with the neutral pose; and
adjusting the set of mesh deformations based on the at least one collision, the set of mesh deformations being adjusted with respect of a placement of the internal features in relation to the external surface of the avatar head, and wherein the set of mesh deformations are adjusted prior to performing the SSDR procedure.

12. The computing device of claim 11, wherein:
detecting the at least one collision between the external surface of the avatar head and the internal features of the avatar head based on the set of mesh deformations and the mesh associated with the neutral pose comprises:
identifying the external surface and the internal features of the avatar head in the neutral pose based on the mesh of the avatar head in the neutral pose;
identifying a first plurality of depth values associated with the external surface of the avatar head in each of the plurality of poses;
identifying a second plurality of depth values associated with the internal features of the avatar head in each of the plurality of poses; and
determining the at least one collision when at least one of the second plurality of depth values for a pose is greater than a corresponding at least one of the first plurality of depth values of the pose, and
adjusting the set of mesh deformations comprises:
modifying the at least one of the second plurality of depth values for the pose to be less than the corresponding at least one of the first plurality of depth values for the pose.

13. The computing device of claim 10, wherein performing the SSDR procedure to compute the LBS rig based on the set of mesh deformations comprises:
computing a set of rigid joint transforms for each of the plurality of poses, wherein a set of input skinning weights are unchanged during the computation of the set of rigid joint transforms; and
computing a set of final skinning weights for each of the plurality of poses while holding the set of rigid joint transforms constant, wherein the LBS rig includes the set of rigid joint transforms and the set of final skinning weights.

14. The computing device of claim 8, wherein computing the adjusted head cage for the avatar head based on the correspondence between the mesh of the avatar head in the neutral pose and a template head cage comprises:
identifying a correspondence between the mesh of the avatar head in the neutral pose and an initial head cage;
computing an adjusted head cage for the avatar head based on the correspondence; and
aligning the adjusted head cage to the mesh associated with the neutral pose of the avatar head.

15. A non-transitory computer-readable medium storing instructions, which when executed by a processor, cause the processor to perform operations comprising:
computing a linear blend skinning (LBS) rig associated with an avatar head based on a set of mesh deformations for a plurality of poses of the avatar head, the LBS rig including a set of skinning joints and a set of joint weights, each joint weight of the set of joint weights being assigned to a vertex of a mesh of the avatar head in a neutral pose;
computing an adjusted head cage for the avatar head based on a correspondence between the mesh of the avatar head in the neutral pose and a template head cage using a landmark-prediction model or a regression model;
animating one or more facial features of the avatar head based on the LBS rig; and
animating one or more of hair or clothing of the avatar head based on the adjusted head cage.

16. The non-transitory computer-readable medium of claim 15, wherein computing the LBS rig associated with the avatar head based on the set of mesh deformations for the plurality of poses comprises:
generating the set of mesh deformations for the plurality of poses based on the mesh associated with the neutral pose of the avatar head and a plurality of pose vectors using a deformation-prediction model, each of the plurality of pose vectors being associated with a respective pose of the plurality of poses; and
performing a Smooth Skinning Decomposition for Rigid Bones (SSDR) procedure based on the set of mesh deformations.

17. The non-transitory computer-readable medium of claim 16, wherein computing the LBS rig associated with the avatar head based on the set of mesh deformations for the plurality of poses comprises:
detecting at least one collision between an external surface of the avatar head and internal features of the avatar head based on the set of mesh deformations and the mesh associated with the neutral pose; and
adjusting the set of mesh deformations based on the at least one collision, the set of mesh deformations being adjusted with respect of a placement of the internal features in relation to the external surface of the avatar head, and wherein the set of mesh deformations are adjusted prior to performing the SSDR procedure.

18. The non-transitory computer-readable medium of claim 17, wherein:
detecting the at least one collision between the external surface of the avatar head and the internal features of the avatar head based on the set of mesh deformations and the mesh associated with the neutral pose comprises:
identifying the external surface and the internal features of the avatar head in the neutral pose based on the mesh of the avatar head in the neutral pose;
identifying a first plurality of depth values associated with the external surface of the avatar head in each of the plurality of poses;
identifying a second plurality of depth values associated with the internal features of the avatar head in each of the plurality of poses; and
determining the at least one collision when at least one of the second plurality of depth values for a pose is greater than a corresponding at least one of the first plurality of depth values of the pose, and
adjusting the set of mesh deformations comprises:
modifying the at least one of the second plurality of depth values for the pose to be less than the corresponding at least one of the first plurality of depth values for the pose.

19. The non-transitory computer-readable medium of claim 16, wherein performing the SSDR procedure to compute the LBS rig based on the set of mesh deformations comprises:
computing a set of rigid joint transforms for each of the plurality of poses, wherein a set of input skinning weights are unchanged during the computation of the set of rigid joint transforms; and
computing a set of final skinning weights for each of the plurality of poses while holding the set of rigid joint transforms constant, wherein the LBS rig includes the set of rigid joint transforms and the set of final skinning weights.

20. The non-transitory computer-readable medium of claim 15, wherein computing the adjusted head cage for the avatar head based on the correspondence between the mesh of the avatar head in the neutral pose and a template head cage comprises:
identifying a correspondence between the mesh of the avatar head in the neutral pose and an initial head cage;
computing an adjusted head cage for the avatar head based on the correspondence; and
aligning the adjusted head cage to the mesh associated with the neutral pose of the avatar head.
